(19) United States
(12) Patent Application Publication
(10) Pub. No.: US 2026/0161180 A1
(43) Pub. Date: Jun. 11, 2026

(54) BIONIC ROBOT AND VACUUM SPORE TRAP

(71) Applicant: North Carolina State University, Raleigh, NC (US)

(72) Inventors: Lirong Xiang, Raleigh, NC (US); Lina Quesada, Raleigh, NC (US); Weilong He, Raleigh, NC (US); Mariana Prieto Torres, Raleigh, NC (US); Zhenghua Zhang, Raleigh, NC (US)

(21) Appl. No.: 19/408,726

(22) Filed: Dec. 4, 2025

Related U.S. Application Data
(60) Provisional application No. 63/728,208, filed on Dec. 5, 2024.

(51) Int. Cl. G05D 1/656; G01N 1/22; G05D 105/80; G05D 109/12

(52) U.S. Cl. CPC G05D 1/656; G01N 1/2273; G05D 2105/80; G05D 2109/12

(57) ABSTRACT

Various examples are provided related to a bionic robot, a vacuum spore trap, and methods of use thereof. In some embodiments, a vacuum spore trap can have a wind collection lid with a plurality of rod placement compartments, a ducted fan where the ducted fan draws air though the wind collection lid, a battery, and an electronic speed controller where the electronic speed controller controls the speed of the ducted fan. In some embodiments, a bionic robot can have a plurality of legs, each of which have three degrees of freedom, a frame connected to each leg, a sensing system having an inertial measurement unit mounted to the frame and a plurality of force sensors mounted to each led, and a control system having a motion controller and a data processor. In some embodiments the vacuum spore trap can be mounted on the bionic robot.

### CROSS REFERENCE TO RELATED APPLICATIONS

This application claims priority to, and the benefit of, U.S. provisional application entitled “BIONIC ROBOT AND VACUUM SPORE TRAP” having Ser. No. 63/728,208, filed Dec. 5, 2024, which is hereby incorporated by reference in its entirety.

### BACKGROUND

The global population is projected to reach 9.75 billion by 2050. To feed such a large population, the world's crop calorie production would have to increase to 1,406 trillion, an increase of 27% from 2023. Modern agriculture faces global challenges such as climate change, soil degradation, water scarcity, and labor shortages. Subsequently, implementing agricultural automation and precision agriculture is a viable response to these challenges for continuous field data collection and precision operations.

### SUMMARY

In accordance with the purpose(s) of this disclosure, as embodied and broadly described herein, the disclosure, in various aspects, relates to a bionic robot and a vacuum spore trap and methods of use thereof. Embodiments of the present disclosure include a system having a vacuum spore trap where the vacuum spore trap has a wind collection lid with a plurality of rod placement compartments; a ducted fan where the ducted fan draws air though the wind collection lid; a battery; and an electronic speed controller where the electronic speed controller controls the speed of the ducted fan. Other embodiments of the present disclosure include a system of a bionic robot, where the bionic robot has a plurality of legs, each of which have three degrees of freedom; a frame connected to each leg; a sensing system having an inertial measurement unit mounted to the frame and a plurality of force sensors mounted to each led; and a control system having a motion controller and a data processor. In some embodiments the vacuum spore trap can be mounted on the bionic robot.

The vacuum spore trap can further include a microcontroller connected to the electronic speed controller, and a wireless module wirelessly connected to the microcontroller where the wireless module sends command signals to the microcontroller to control the functions of the ducted fan. In some examples, at least one collection rod is placed in at least one of the rod placement compartments. The collection rod can be coated with an adhesive. In some examples, the vacuum spore trap further includes a portable handle. Moreover, in some examples, the vacuum spore trap can be mounted to the bionic robot via the portable handle. In some examples, the vacuum spore trap can further include a control switch.

The bionic robot can further include a LIDAR, a plurality of cameras, and a plurality of range sensors. In some examples, the plurality of legs is six legs. In some examples, each leg comprises at least three servos and at least three connectors and some can include a proximal servo with horizontal rotational degrees of freedom, a medial servo with vertical rotational degrees of freedom, and a distal servo with vertical rotational degrees of freedom. Further, in some examples, the legs can switch between a high clearance motion mode and a low clearance motion mode. In some examples, the bionic robot has a maximum weight of approximately 10 kilograms. Moreover, in some examples, the bionic robot can maintain a payload of at least 8 kilograms. And, in some examples, the bionic robot has an operation endurance time of at least 2 hours.

Other systems, methods, devices, features, and advantages of the devices and methods will be or become apparent to one with skill in the art upon examination of the following drawings and detailed description. It is intended that all such additional systems, methods, devices, features, and advantages be included within this description, be within the scope of the present disclosure, and be protected by the accompanying claims.

### BRIEF DESCRIPTION OF THE DRAWINGS

Further aspects of the present disclosure will be more readily appreciated upon review of the detailed description of its various embodiments, described below, when taken in conjunction with the accompanying drawings. The components in the drawings are not necessarily to scale, emphasis instead being placed upon clearly illustrating the principles of the present disclosure. Moreover, in the drawings, like reference numerals designate corresponding parts throughout the several views.

FIGS. 1A and 1B are illustrations of a robot CAD model according to various embodiments of the present disclosure.

FIG. 2 is a flowchart illustrating the architecture of the integrated robotic sensing and motion system according to various embodiments of the present disclosure.

FIG. 3 is an illustration of the robot body according to various embodiments of the present disclosure.

FIG. 4 is an illustration of an exploded view of the whole leg according to various embodiments of the present disclosure.

FIGS. 5A and 5B are illustrations of comparisons of the clearance when the robot is marching and step-over modes according to various embodiments of the present disclosure.

FIG. 6 is a flowchart of the robot switching motion modes according to various embodiments of the present disclosure.

FIGS. 7A and 7B are illustrations of 3D plots of the robot foot's trajectory according to various embodiments of the present disclosure.

FIG. 8 is an illustration of a simulation of a robot traveling uphill and downhill on a 15° inclined surface according to various embodiments of the present disclosure.

FIG. 9 is an illustration of the maximum slope the robot system can travel according to various embodiments of the present disclosure.

FIGS. 10A and 10B are illustrations of simulation results that demonstrate the legged robot's ability to cross obstacles, navigate furrows, and climb joists according to various embodiments of the present disclosure. FIG. 10A depicts sequential simulation snapshots showcasing a legged robot navigating through a challenging obstacle course with varying terrains and obstructions. FIG. 10B illustrates a graphical representation of the robot's vertical displacement over time, indicating its stability and agility during the obstacle course navigation.

FIGS. 11A and 11B are illustrations of two examples of the robot to cross an obstacle on a flat surface according to various embodiments of the present disclosure.

FIG. 12 is an illustration of variation in the robot's pitch angle during slope ascent according to various embodiments of the present disclosure.

FIG. 13 is an illustration of variation in pitch angle as the robot navigates grassy terrain according to various embodiments of the present disclosure.

FIG. 14 is an illustration of variation of the pitch angle of the robot as it walks through a complex grassy field and crosses and obstacle according to various embodiments of the present disclosure.

FIGS. 15A and 15B are illustrations of a top view (FIG. 15A) and a side view (FIG. 15B) of a vacuum spore trap according to various embodiments of the present disclosure.

FIG. 16 is an illustration of one example of the vacuum spore trap being mounted on a drone according to various embodiments of the present disclosure.

FIGS. 17A and 17B are graphical illustrations depicting the total pressure contour (FIG. 17A) and the velocity contour (FIG. 17B) of the vacuum spore trap mounted on a drone according to various embodiments of the present disclosure.

FIGS. 18A and 18B are illustration of the wind collection lid without (FIG. 18A) and with (FIG. 18B) collection rods placed in the collection rob placement compartments according to various embodiments of the present disclosure.

FIGS. 19A and 19B are illustrations of varying views of one example of a vacuum spore trap configuration according to various embodiments of the present disclosure.

FIGS. 20A and 20B are illustrations of varying views of one example of a vacuum spore trap configuration according to various embodiments of the present disclosure.

FIGS. 21A and 21B are illustrations of varying views of one example of a vacuum spore trap configuration according to various embodiments of the present disclosure.

FIGS. 22A and 22B are illustrations of varying views of one example of a vacuum spore trap configuration according to various embodiments of the present disclosure.

FIG. 23 depicts an example of a user interface for the software of the wireless module according to various embodiments of the present disclosure.

FIG. 24 is an illustration of an experimental setup that was used to test the vacuum spore trap according to various embodiments of the present disclosure.

FIGS. 25A-F depict experimental results from the experiment depicted in FIG. 24 according to various embodiments of the present disclosure.

FIGS. 26A and 26B depict examples of various airborne pathogen biosurveillance tools according to various embodiments of the present disclosure. FIG. 26A shows representative spore traps, including a volumetric trap, a rotating arm trap, a vacuum trap, a rain trap, and swabbing worker gloves. FIG. 26B shows representative mobile platforms that can carry traps or sensors, including a rover, a drone, a robotic quadruped (“robotic dog”), and a spider robot.

FIGS. 27A-D depict example use-case scenarios of trap-vehicle combinations for biosurveillance according to various embodiments of the present disclosure. In FIG. 27A, dense fields without spacing between plants can be suitable for biosurveillance with drones or legged robots that can clear the canopy. In FIG. 27B, plantings with defined rows can allow for biosurveillance with rovers or legged robots. In FIG. 27C, commercial greenhouses and, in FIG. 27D, produce storage houses can allow for biosurveillance with vacuum traps placed in strategic areas.

FIG. 28 shows a pathosystem's physiological taxonomy (top row) should be matched to the optimal sensing modality (middle row) relative to the practical engineering, sensing, and end user constraints (bottom row) according to various embodiments of the present disclosure. Pathosystem measurement can occur optimally with a given sensing modality from the ground (manual, automated ground vehicle sampling), proximal/air (UGV, post-mounted), or satellite to balance throughput with sensitivity and specificity. Finally, engineering constraints can be either optimal (green), marginal or moderately constrained (yellow ball), or sub-optimal (red bar).

FIGS. 29A-F show (FIG. 29A) a set up of rotarod ground trap with accompanying battery box in commercial field, (FIG. 29B) a set up of rover with vacuum trap on research plots, (FIG. 29C) a set up of drone with vacuum trap hanging from tether, (FIG. 29D) a rotarod trap, (FIG. 29E) a vacuum trap (front), and (FIG. 29F) a vacuum trap with sampling rods (bottom), according to various embodiments of the present disclosure.

FIGS. 30A-C show percentage of spore trap sampling results in all sampling locations according to various embodiments of the present disclosure. Each column of the bar graph represents a different type of vehicle/trap combination and the number in parenthesis represents the run time in minutes of each of the spore traps. The types of traps are as follows: Drone (drone+vacuum trap), Drone control (rotarod trap running at the same time as drone trap), Ground (rotarod trap). The colors in each bar graph represent the categorization of results from the clade qPCR as follows: blue represents samples that were categorized as clade 2 only, red represents samples that were categorized as clade 1 only, purple represent samples that were categorized as having the presence of both clades on a single sample and the grey represents samples that were categorized as having no P. cubensis. The numbers at the right side of the graph represent the total N for each given type of trap. FIGS. 30A and 30B show results for the 2023 and 2024 field season, on the research plot at Central Crops Research Station (CCRS). FIG. 30C shows results for the sampling in 2024 at the commercial field located in Duplin county, NC.

FIG. 31 depicts disease symptoms detection and qPCR detection by week at the research location in 2023 according to various embodiments of the present disclosure. The solid blue line on week 5 represents the first clade 2 qPCR detection. The red line on week 6 represents the first clade 1 qPCR detection. The green arrow on week 9 represents the first time CDM symptoms were confirmed in a cucumber plant. The orange arrow on week 10 represents the first time CDM symptoms were confirmed in a squash plant. The pink arrow in week 15 represents that the plots were replanted.

FIG. 32 depicts disease symptoms detection and qPCR detection by week at the research location in 2024 according to various embodiments of the present disclosure. The solid blue line on week 1 represents the first clade 2 qPCR detection. The purple line on week 11 represents both clade 1 and clade 2 qPCR detection. The green arrow on week 10 represents the first time CDM symptoms were confirmed in a cucumber plant. The orange arrow on week 11 represents the first time CDM symptoms were confirmed in a squash plant.

FIGS. 33A-D depict 3D printed vacuum trap specifications according to various embodiments of the present disclosure. FIG. 33A shows a top view. FIG. 33B shows a side view. FIG. 33C shows a bottom view, without rods. In some embodiments, the trap can fit up to 104 rods. FIG. 33D shows a bottom view, with 8 rods present.

FIG. 34 shows a generalized logistic regression mixed model, with a fixed effect for traps and with random effects, according to various embodiments of the present disclosure.

### DETAILED DESCRIPTION

Before the present disclosure is described in greater detail, it is to be understood that this disclosure is not limited to particular embodiments described, as such may, of course, vary. It is also to be understood that the terminology used herein is for the purpose of describing particular embodiments only, and is not intended to be limiting, since the scope of the present disclosure will be limited only by the appended claims.

Where a range of values is provided, it is understood that each intervening value, to the tenth of the unit of the lower limit (unless the context clearly dictates otherwise), between the upper and lower limit of that range, and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, the preferred methods and materials are now described.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure. Any recited method can be carried out in the order of events recited or in any other order that is logically possible.

The following examples are put forth to provide those of ordinary skill in the art with a complete disclosure and description of how to perform the methods and use the compositions and compounds disclosed and claimed herein. Efforts have been made to ensure accuracy with respect to numbers (e.g., amounts, measurements, etc.), but some errors and deviations should be accounted for.

Before the embodiments of the present disclosure are described in detail, it is to be understood that, unless otherwise indicated, the present disclosure is not limited to particular materials, machines, computing processes, or the like, as such can vary. It is also to be understood that the terminology used herein is for purposes of describing particular embodiments only and is not intended to be limiting. It is also possible in the present disclosure that steps can be executed in different sequence where this is logically possible.

It should be noted that ratios, amounts, and other numerical data can be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to about 5%” should be interpreted to include not only the explicitly recited values of about 0.1% to about 5%, but also include individual values (e.g., 1%, 2%, 3%, and 4%) and the sub-ranges (e.g., 0.5%, 1.1%, 2.2%, 3.3%, and 4.4%) within the indicated range. Where the stated range includes one or both of the limits, ranges excluding either or both of those included limits are also included in the disclosure, e.g., the phrase “x to y” includes the range from ‘x’ to ‘y’ as well as the range greater than ‘x’ and less than ‘y’. The range can also be expressed as an upper limit, e.g., ‘about x, y, z, or less’ and should be interpreted to include the specific ranges of ‘about x’, ‘about y’, and ‘about z’ as well as the ranges of ‘less than x’, less than y′, and ‘less than z’. Likewise, the phrase ‘about x, y, z, or greater’ should be interpreted to include the specific ranges of ‘about x’, ‘about y’, and ‘about z’ as well as the ranges of ‘greater than x’, greater than y′, and ‘greater than z’. In some embodiments, the term “about” can include traditional rounding according to significant figures of the numerical value. In addition, the phrase “about ‘x’ to ‘y”, where ‘x’ and ‘y’ are numerical values, includes “about ‘x’ to about ‘y’”.

### DISCUSSION

Disclosed are various approaches for constructing a bionic robot, for constructing a vacuum spore trap, and for mounting a vacuum spore trap on a bionic robot. Although the vacuum spore trap is discussed in respect to downy mildew spore collection and other agricultural applications, the vacuum spore trap has various other applications including collecting samples such as spores, pollen, mold, allergens, environmental air particles, airborne pathogens, and any other suitable airborne particle. Similarly, while the bionic robot is discussed herein in regards to an agricultural application, the bionic robot can be used in various applications to traverse complex terrains.

Unlike industrial robots that work in predictable and controlled environments, agricultural robots have to deal with unstructured or semi-structured environments with tasks that are highly stochastic. Robots often need to be equipped with a range of sophisticated sensors to accommodate complex environments and improve motion accuracy. This reliance on sensors can result in increased robot costs. In recent years, advances in sensing technology have led to a gradual decrease in the cost of sensors and an increase in their durability. These advances have allowed researchers and companies to develop and build more affordable robots.

Precision agriculture continues to evolve in the search for efficient, sustainable, and cutting-edge technological solutions. Traditional agricultural machinery often presents several disadvantages, including cumbersome transportation, soil compaction, land damage, and limitations imposed by varying field terrains. Therefore, smaller, precise, and flexible robots are becoming a trend. These robots can move flexibly through complex terrain while reducing compaction and damage to the soil. Moreover, the integration of automatic control, sensing, and computer technologies has facilitated advances in agricultural robot design and holds great promise for modern agriculture. Furthermore, a cluster of robots can be deployed over large areas of farmland, where individual units work collaboratively to enhance operational efficiency. In addition, robot clusters can improve the system's robustness and reduce the chances of delays due to possible malfunctions of individual machines. This cluster-based method improves the reliability of agricultural operations, optimizing resource utilization and task distribution, leading to more consistent and effective farming outcomes.

Most previous research on agricultural robots has focused on wheeled robots and unmanned aerial vehicles (UAVs). The configuration of wheeled robots is ideal for autonomous navigation and harvesting in rows and columns of farmland, such as orchards, maize fields, and strawberry fields, where the ground is relatively flat, with fewer obstacles in the path and a relatively straightforward navigation line. However, for fields without rows and columns, wheeled robots are unsuitable for use due to their poor adaptation to terrain conditions and limited maneuverability. Additionally, the robot's wheels may cause damage to plants as there is no clearance for a wheeled robot to drive through. UAVs are also gaining interest due to their low cost, portability, high efficiency, high throughput, and simplicity of operation. However, aerial imaging systems have low accuracy because of long working distances. They can only capture top-view images and are unable to assess plant features that can only be observed in other viewpoints, for example, under the canopy. Furthermore, when UAVs operate outdoors, their flight stability is significantly affected by wind. This issue is exacerbated when there are substantial changes in load, making them prone to control instability. When flying at low altitudes, UAVs are likely to collide with numerous obstacles, such as tree branches, increasing operational risks. Therefore, drones may not be the best choice for tasks requiring precise control, such as picking and carrying operations.

Compared to wheeled robots and UAVs, legged robots have shown much better terrain adaptation and maneuverability performance. With more degrees of freedom (DOF) and multiple footing points, legged robots can pass through complex environments and have many applications in disaster rescue and material transportation. Operators can adjust the robot's center of gravity by precisely controlling the angle of each joint to adapt to different ground conditions. In addition, by precisely controlling the landing position of each leg, the robot can effectively avoid obstacles, thereby increasing its operational efficiency and safety in unpredictable environments. This advanced mobility and adaptability allow legged robots to play a role in outdoor operations.

In the field of legged robots, quadruped robots have fewer support points compared to hexapod robots. Consequently, quadrupeds alternately lift each leg during movement. If a suitable support point cannot be found within the robot's accessible space, its ability to progress is limited. Additionally, the dynamic characteristics of quadrupedal motion can employ constant body balance maintenance, increasing the computational complexity of control algorithms and power consumption. This complexity can be reflected in shorter operational endurance times. In contrast, with more support points, hexapod robots provide more stable support and higher dexterity, making them more suitable for agricultural applications where higher load capacities and longer endurance are required.

Hexapod robots are exceptionally well-suited for applications necessitating high precision and complexity. However, improving the stability and efficiency of legged robots in unstructured environments, such as agriculture, remains a challenge. Various embodiments of the present disclosure introduce a bionic hexapod robot with innovative control mechanisms to address the challenges of applying legged robots in agricultural scenarios. The bionic robot is promising particularly when maneuvering among the Cucurbitaceae family of plants, for example. By combining the bionic robot with a vacuum spore trap, vital assessment of the crop can be collected.

Downy mildew of cucurbits is a global threat to the Cucurbitaceae family of plants. It is caused by the oomycete pathogen Pseudoperonospora cubensis, which produces airborne spores that can travel hundreds of miles and infect more than 60 different plant species. If left unmanaged, this disease can lead to a significant decrease in yield, reduced nutrients, and secondary rot. Traditional detection methods often come too late and can easily be confused with similar diseases. Therefore, a specialized method for accurately detecting airborne spores can be desired.

Currently, there is no effective early detection method for downy mildew of cucurbits. Since the disease is difficult to identify in its early stages, it is usually diagnosed by using a low-power microscope or a dissecting microscope to observe symptoms on the upper side of the leaves and spore formation on the lower side of the leaves. However, this method is time-consuming and laborious for large-scale crops, as it involves sampling at different locations and confirming the presence of the P. cubensis pathogen by examining the spore sacs and pigmentation.

To address this issue, a spore trap has been developed, in various embodiments of the present disclosure, that does not use leaves to collect effective spores. An impact sampler that uses inertia to collect particles from the air has become a promising solution. These samplers redirect the airflow to bypass the surface of solid or agar coating to separate particles and deposit them onto a surface. Generally, the surface is coated with an adhesive to ensure particle adhesion. There are various types of impact samplers available, including the slit impactor for total spores, the rotating arm impactor for total spores, and the sieve impactor for culturable fungi. Although impact samplers are widely used and can effectively collect particles in the air, there are some limitations, such as they are not suitable for collecting certain types of particles, such as those that are too small or too large to be effectively separated by the impactor.

To achieve this goal, various embodiments of the present disclosure used a microcontroller (e.g., an Arduino) controlled spore trap system, which includes a ducted fan, a hood, a sticky collection rod, an electronic speed controller, and a wireless communication module (e.g., a Bluetooth HC-06 module). An advantage of this design is the vacuum's ability to suck air quickly to digest a large volume of air to increase the chance of collecting samples. Further, the vacuum spore trap contains a plurality of rod placement compartments which allows for a plurality of rods to be used to also increase the chance of collecting samples.

Downy mildew of cucurbits can lead to a significant decrease in crop yield, posing a serious threat to global food security. Early detection and prevention of such diseases can ensure food security and sustainable agricultural production. The newly introduced device can help farmers and researchers to detect the disease in its early stages, enabling them to take necessary measures to prevent its spread and minimize the damage.

Accordingly, various embodiments of the present disclosure are directed to constructing a bionic robot, constructing a vacuum spore trap, and mounting a vacuum spore trap on a bionic robot. Various embodiments of the present disclosure introduce a novel bionic hexapod robot designed for agricultural applications to address the limitations of traditional wheeled and aerial robots. According to various examples of the present disclosure, the design can feature a hexapod robot with high agility and dexterity. A significant innovation of this bionic robot is its terrain-adaptive gait and adjustable clearance, which ensure body stability as the robot travels over different terrains and crosses obstacles of varying heights. Various embodiments of the present disclosure also introduce a vacuum spore trap that can be independent or mounted on drones, rovers, or the bionic robot as described herein.

In the following discussion, a general description of the system and its components is provided, followed by a discussion of the operation of the same. Although the following discussion provides illustrative examples of the operation of various components of the present disclosure, the use of the following illustrative examples does not exclude other implementations that are consistent with the principles disclosed by the following illustrative examples.

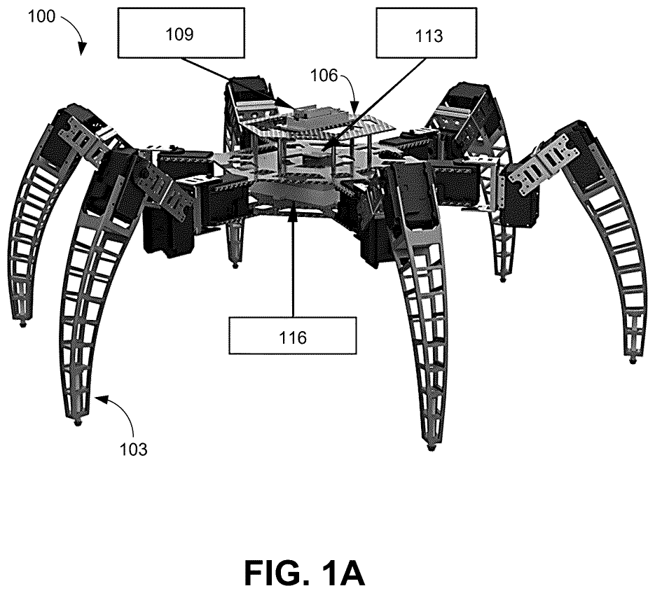

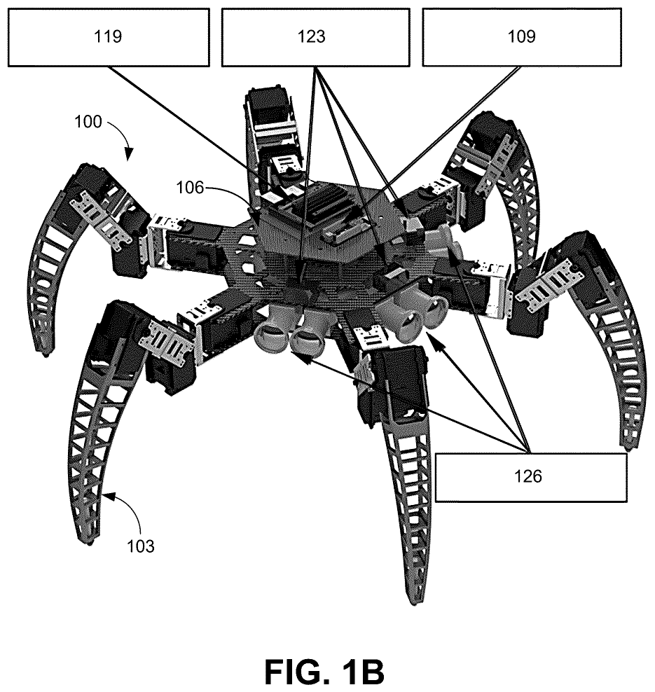

With reference to FIGS. 1A-B, shown is a bionic robot 100 with a plurality of legs 103 and a frame 106. As shown in FIGS. 1A and 1B, in some examples, the bionic robot 100 has six legs 103. In some examples, the bionic robot 100 can have a maximum weight of 10 kilograms. Further, in some examples, the bionic robot 100 can maintain a payload of at least 8 kilograms. The configuration of the legs 103 allows the bionic robot 100 to mimic the movement of natural creatures. In some examples, various sensors and control systems can be attached to the frame 106 to advance the capabilities of the bionic robot 100.

The frame 106 of the robot body is used to support the robot's overall structure and connect to each system. In various examples, carbon fiber can be used for the frame 106. Carbon fiber allows the frame 106 to be light weight while maintaining stability to increase the load capacity of the robot. In some examples, the frame 106 can feature a double-layer construction with six nylon struts in the center for support. This design increases the available space within the fuselage and provides enhanced resistance to bending moments. In some examples, the frame 106 is divided into three layers by a double-layered base plate, allowing the user to configure the frame 106 with the sensing and control systems. In some examples, the thickness of the base plate can be approximately 2 mm to ensure high stiffness and low weight.

In FIG. 1A, a motion controller 109, an inertial measurement unit (IMU) 113, and a battery 116 are shown attached to the frame 106 of the bionic robot 100 according to various embodiments of the present disclosure. The motion controller 109 can serve as a part of the bionic robot 100's control system. The motion controller 109, as part of the control system, givens commands to regulate the angle, rotational speed, and torque of the servos and various other motion commands. The IMU 113 can be a part of the sensing system and can allow for real-time monitoring of the bionic robot 100's attitude during movement. The IMU can measure the robot's inclination, angular velocity, and angular acceleration in pitch, yaw, and roll directions, which can be used to provide feedback on the current robot posture. Therefore, in some examples, the bionic robot 100 can adjust the attitude to maintain balance. The battery 116 can be attached to the frame 106 of the bionic robot 100. The battery 116 can power the robot's motion and control system. In some examples, the battery 116 allows the bionic robot 100 to have an endurance of at least two hours.

In FIG. 1B, various items are shown attached to the frame 106 including: motion controller 109, data processor 119, range sensors 123, and cameras 126. The motion controller 109 and the data processor 110 can be part of the bionic robot 100's control system. In some examples, the motion controller 109 works with the data processor 119 of the control system to process images and point cloud information generated by the camera and LiDAR. In other words, the motion controller 109 works with the data processor 119 to process information gathered by the sensing system to generate motion commands. The range sensors 123 can be a part of the environmental sensing system. In some examples, there are three range sensors 123. The cameras 126, also a part of the environmental sensing system, can generate depth images that can be paired with the data from the range sensors 123. In some examples, the environmental sensing system can further include LiDAR technology which can determine ranges by measuring the time for reflected light to return from a targeted laser. The combined data from the range sensors 123 the cameras 126, and the LiDAR technology can provide instance distance measurement which aids in obstacle avoidance and object detection.

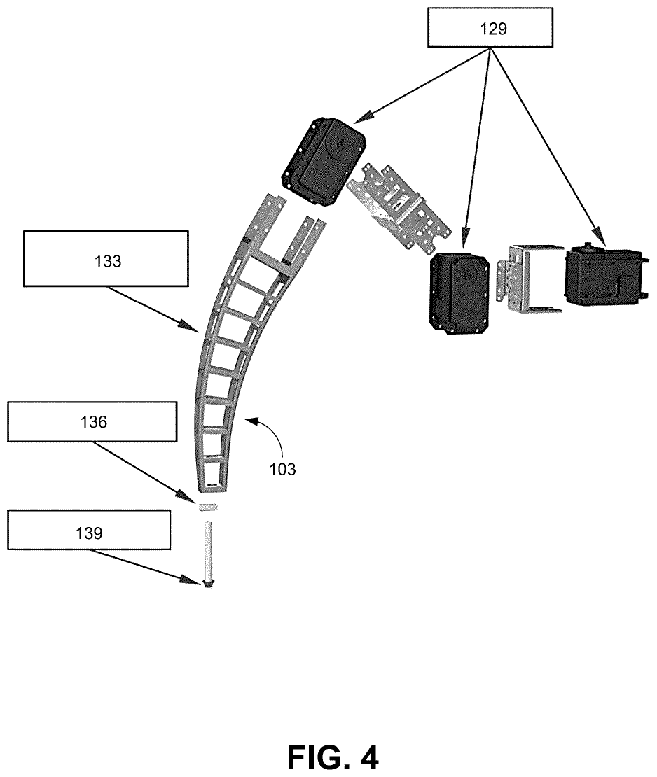

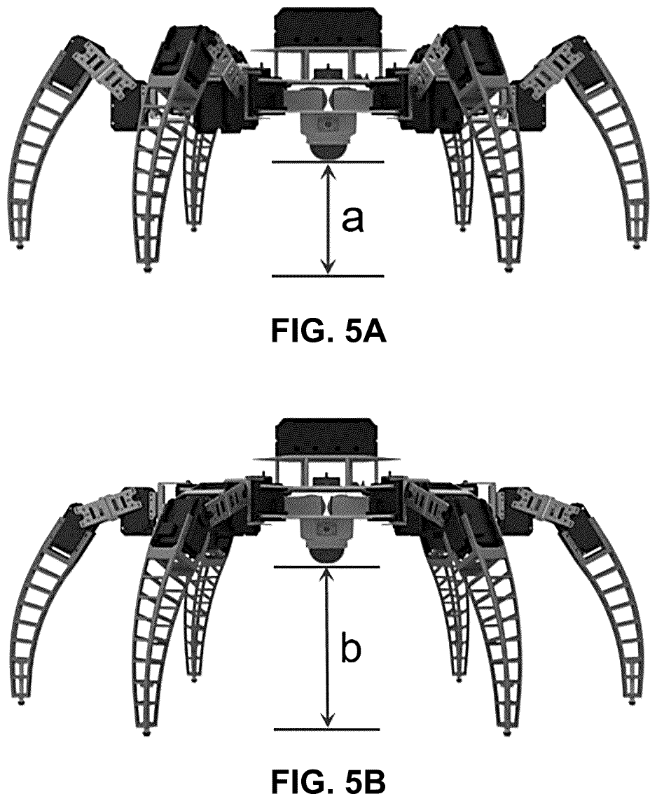

With reference to FIG. 4, shown is an exploded view of a leg 103. The proximal end of each leg 103 is connected to the frame 106 of the bionic robot 100 as shown in FIGS. 1A and 1B. The plurality of legs 103 can have three degrees of freedom, giving the bionic robot 100 a range of movement that allows the bionic robot 100 the ability to navigate complex terrains. Each leg 103 can have at least three servos 129 and three connectors 133 where each leg 103 can have a proximal servo with horizontal rotational degrees of freedom to move forward and backwards, a medial servo with vertical rotational degrees of freedom to control up and down movements, and a distal servo with vertical rotational degrees of freedom to further control up and down movements. Thus, in some examples, the plurality of legs 103 can switch between a high clearance motion mode and a low clearance motion mode (see FIGS. 5A and 5B). The distal connector 133 can have an attached force sensor 136 and rubber sole 139 at its distal end. The force sensor 136 can work with the IMU 113 to record comprehensive data on the bionic robot 100's attitude and motion dynamics. In some examples, the rubber sole 139 adds stability and traction to the bionic robot 100.

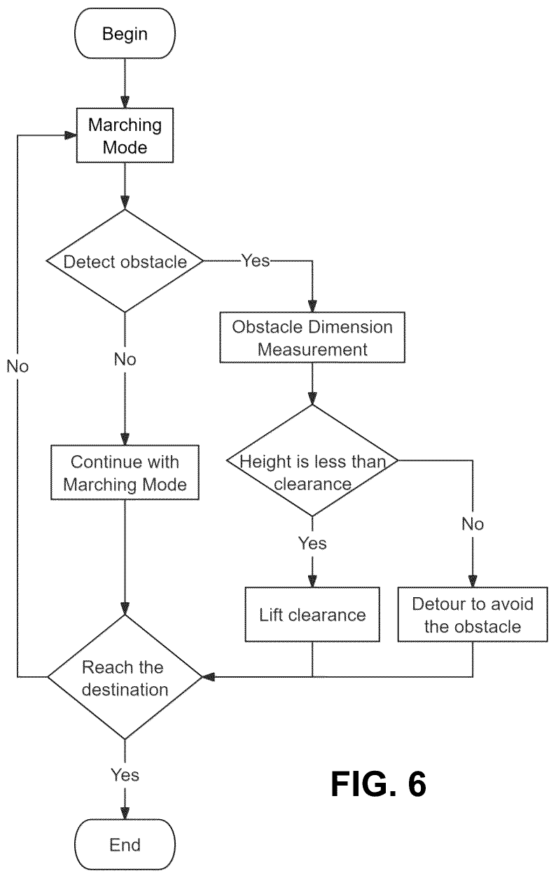

FIG. 6 shows a flow diagram depicting an example of the operation of the robot's 100 control system. As shown in FIG. 6, the control system can begin by initiating a marching mode for the robot 100, where the robot 100 is configured to “march” or propel itself forward using the plurality of legs 103. In some examples, the control system can communicate with the environmental sensing system to detect obstacles. Using one or more of the sensors described above, the robot 100 can determine whether an obstacle exists in the path of one or more of the legs 103. If an obstacle is detected, one or more sensors can be used to determine an obstacle dimension measurement. Depending at least in part on the obstacle dimension measurement, the control system can determine whether a height of the obstacle is less than a known clearance of a robot leg 103. If the height of the obstacle is less than the clearance of the robot leg 103, the control system can proceed to cause the robot 100 to lift the leg 103 to the clearance height and thus, clear the obstacle. In some examples, when the height of the obstacle is greater than the clearance of the leg 103, the control system can cause the robot 100 to detour in order to avoid the obstacle.

When no obstacle is detected, the control system can cause the robot 100 to continue in marching mode until a destination is reached. In some examples, the robot 100 can use GPS, visual sensors, or other technologies to determine whether a destination has been reached. If the destination has been reached, the robot 100 can end its journey. However, if the destination has not been reached, the robot 100 will continue in marching mode.

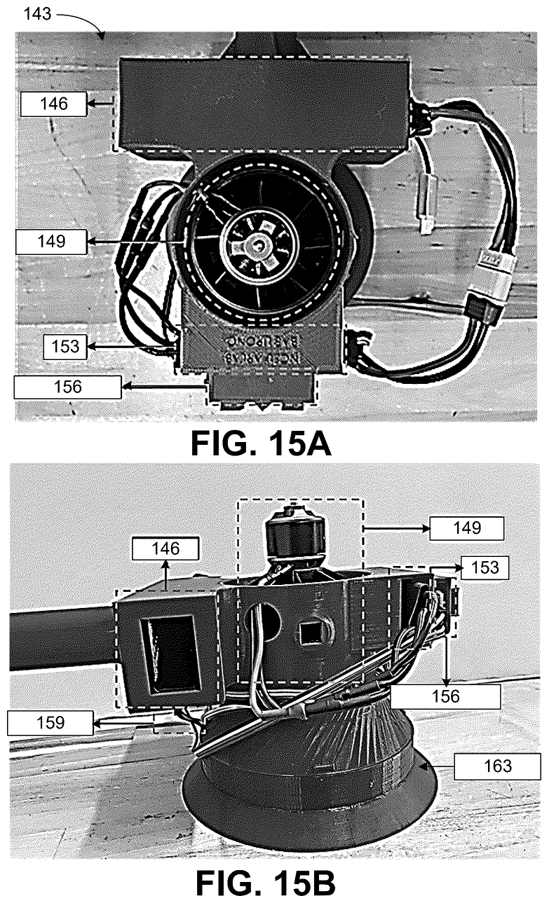

With reference to FIGS. 15A and 15B, shown is a vacuum spore trap according to various embodiments of the current disclosure. FIG. 15A is a top view and FIG. 15B is a side view of the vacuum spore trap 143. The vacuum spore trap 143 can include a battery 146, a ducted fan 149, an electronic speed controller 153, a wireless module 156, a microcontroller 159, and a wind collection lid 163. The battery 146 can be used to power the device. The ducted fan 149 is designed to produce convergent airflow to increase the speed and pressure of the air being drawn into the spore trap vacuum 143. The ducted fan 149 can be configured to draw air through the wind collection lid 163. In some examples, the ducted fan 149 can be switched on and off via a control switch. The electronic speed controller (ESC) 153 can regulate the speed of the fan. The ESC 153 can be connected to the microcontroller 159. In some examples, the microcontroller 159 can provide the control signals to the ESC 153. Further in some examples, the microcontroller 159 can be connected to a wireless module 156 that can receive commands from a wireless device (e.g., Bluetooth enabled device) and can send the command signals to the microcontroller 159. The command signals can include parameter such as start, stop, speed, duration, and any other suitable parameter for the ducted fan 149.

This allows a user to wirelessly control the vacuum spore trap 143. The wind collection lid 163 can be connected to the ducted fan 149. The wind collection lid 163 can accelerate and trap the surrounding air to guide the air through the device and through the ducted fan 149. The wind collection lid 163 can have a plurality of rod placement compartments. The collection rods can be placed in the plurality of rod placement compartments. In some examples, the collection rods are coated in with an adhesive to enable airborne spores to attach to the collection rods. The wind collection lid 163 can have various compartments to house the battery 146 in a battery compartment, the electronic speed controller 153 and in some examples the microcontroller 159 in a controller compartment, and the wireless module 156 in a wireless module compartment. In some examples, the vacuum spore trap 143 can include a portable handle. In some examples, the vacuum spore trap 143 can be manually transported by the portable handle. In some examples, the vacuum spore trap 143 can be mounted via the portable handle on bionic robot 100.

Disjunctive language such as the phrase “at least one of X, Y, or Z,” unless specifically stated otherwise, is otherwise understood with the context as used in general to present that an item, term, etc., can be either X, Y, or Z, or any combination thereof (e.g., X; Y; Z; X or Y; X or Z; Y or Z; X, Y, or Z; etc.). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications can be made to the above-described embodiments without departing substantially from the spirit and principles of the disclosure. All such modifications and variations are intended to be included herein within the scope of this disclosure and protected by the following claims.

### Example A

### 1 Introduction

The global population is projected to reach 9.75 billion by 2050. To feed such a large population, the world's crop calorie production would have to increase to 1,406 trillion, an increase of 27% from 2023. Modern agriculture faces global challenges such as climate change, soil degradation, water scarcity, and labor shortages. Subsequently, implementing agricultural automation and precision agriculture is a viable response to these challenges, which relies not only on the development of automation and information technology but also on using high-performance agricultural robots for continuous field data collection and precision operations.

Unlike industrial robots that work in predictable and controlled environments, agricultural robots have to deal with unstructured or semi-structured environments with tasks that are highly stochastic. Robots often need to be equipped with a range of sophisticated sensors to accommodate complex environments and improve motion accuracy. This reliance on sensors can result in increased robot costs. For example, the Spot Robot Dog (Boston Dynamics, Waltham, MA, USA) can carry 14 kg for 90 minutes but costs up to $200,000; the GO 1 EDU Robot Dog (Unitree, Hangzhou, Zhejiang, China) can work for 2 hours with 3 kg payload, and it costs around $10,000. In recent years, advances in sensing technology have led to a gradual decrease in the cost of sensors and an increase in their durability. These advances have allowed researchers and companies to develop and build more affordable robots. For example, the MARS modular robotic system developed by the University of Georgia demonstrates its cost advantages. The basic configuration of MARS costs approximately $2,300, which includes the robot's motion system, hardware framework, and a minimal controller. Additionally, MARS can be optionally equipped with additional RTK-GNSS and RGB cameras to accurately navigate various physical obstacles, including ditches and tree branches, and perform data collection tasks.

Precision agriculture continues to evolve in the search for efficient, sustainable, and cutting-edge technological solutions. Traditional agricultural machinery often presents several disadvantages, including cumbersome transportation, soil compaction, land damage, and limitations imposed by varying field terrains. Therefore, smaller, precise, and flexible robots are becoming a trend. These robots can move flexibly through complex terrain while reducing compaction and damage to the soil. Moreover, the integration of automatic control, sensing, and computer technologies has facilitated advances in agricultural robot design and holds great promise for modern agriculture. Although many robots are still in the developmental stage, they are showing promising results in agricultural tasks. Examples include (1) Spot irrigation and precision weeding, which help to reduce the consumption of water and pesticides, therefore increase the sustainability of agricultural production. (2) Pest and disease detection, where the robot can promptly report areas where pests and diseases are found, allowing for early intervention of pests and diseases. (3) Fruit picking, where the robot can pick fruits automatically using flexible mechanical grippers to make up for the lack of productivity due to labor shortage. Furthermore, a cluster of robots can be deployed over large areas of farmland, where individual units work collaboratively to enhance operational efficiency. In addition, robot clusters can improve the system's robustness and reduce the chances of delays due to possible malfunctions of individual machines. This cluster-based method improves the reliability of agricultural operations, optimizing resource utilization and task distribution, leading to more consistent and effective farming outcomes.

Most previous research on agricultural robots has focused on wheeled robots and unmanned aerial vehicles (UAVs). The configuration of wheeled robots is ideal for autonomous navigation and harvesting in rows and columns of farmland, such as orchards, maize fields, and strawberry fields, where the ground is relatively flat, with fewer obstacles in the path and a relatively straightforward navigation line. However, for fields without rows and columns, wheeled robots can be unsuitable for use due to their poor adaptation to terrain conditions and limited maneuverability. Additionally, the robot's wheels may cause damage to plants as there is no clearance for a wheeled robot to drive through. UAVs are also gaining interest due to their low cost, portability, high efficiency, high throughput, and simplicity of operation. However, aerial imaging systems have low accuracy because of long working distances. They can only capture top-view images and are unable to assess plant features that can only be observed in other viewpoints, for example, under the canopy. Furthermore, when UAVs operate outdoors, their flight stability is significantly affected by wind. This issue is exacerbated when there are substantial changes in load, making them prone to control instability. When flying at low altitudes, UAVs are likely to collide with numerous obstacles, such as tree branches, increasing operational risks. Therefore, drones may not be the best choice for tasks requiring precise control, such as picking and carrying operations.

Compared to wheeled robots and UAVs, legged robots have shown much better terrain adaptation and maneuverability performance. With more degrees of freedom (DOF) and multiple footing points, legged robots can pass through complex environments and have many applications in disaster rescue and material transportation. Operators can adjust the robot's center of gravity by precisely controlling the angle of each joint to adapt to different ground conditions. In addition, by precisely controlling the landing position of each leg, the robot can effectively avoid obstacles, thereby increasing its operational efficiency and safety in unpredictable environments. This advanced mobility and adaptability allow legged robots to play a role in outdoor operations.

In the field of legged robots, quadruped robots have fewer support points compared to hexapod robots. Consequently, quadrupeds alternately lift each leg during movement. If a suitable support point cannot be found within the robot's accessible space, its ability to progress can be limited. Additionally, the dynamic characteristics of quadrupedal motion can involve constant body balance maintenance, increasing the computational complexity of control algorithms and power consumption. This complexity can be reflected in shorter operational endurance times. A commercially available quadrupedal robot (Unitree, Hangzhou, Zhejiang, China) was tested carrying a 3 kg payload and traveling at 2 m/s on flat concrete ground, resulting in an endurance of only approximately 30 minutes. In contrast, with more support points, hexapod robots provide more stable support and higher dexterity, making them more suitable for agricultural applications involving higher load capacities and longer endurance.

Researchers have been working on robot locomotion over the past three decades. Significant advancements have been achieved in the stability and sensitivity of robot locomotion. Intensive research and experimentation have led to the development of advanced algorithms that can be dynamically adapted to speed changes and different terrain types. Numerous studies have validated the performance of hexapod robots in terms of stability, accuracy, and flexibility across various environments, including flat hard surfaces and terrains with regular obstacles. These investigations demonstrate that hexapod robots exhibit superior performance compared to other robotic configurations like quadruped robots. Such attributes render hexapod robots exceptionally well-suited for applications necessitating high precision and complexity. In terms of control algorithms for hexapod robots, some researchers have developed control methods based on neuromodulation mechanisms inspired by biological systems as well as neural networks that mimic the stimulus-response of the nervous system. Meanwhile, other researchers have worked on developing machine learning-based control algorithms. These algorithms provide sophisticated solutions to maintain robot stability in environments with dense obstacles and uneven terrain. However, improving the stability and efficiency of legged robots in unstructured environments, such as agriculture, remains a challenge. To address this issue, a research group at Kyoto University developed a tracking robot based on ambient CO2 concentration. These advances provide solutions for modifying robot behavior based on external environmental inputs. In addition, researchers at ETH Zurich developed another robot that integrates stereo vision for navigation and proprioceptive terrain sensing for adaptive control. Despite these technological advances, the widespread use of hexapod robots in agriculture still faces significant challenges, such as adapting to different soil properties, avoiding plant damage, and improving endurance, which led to the limited use of hexapod robots in agricultural practices.

The present disclosure introduces a bionic hexapod robot with innovative control mechanisms to address the challenges of applying legged robots in agricultural scenarios. The objectives of this study are to: (1) conceptualize and create a design framework for a terrain-adaptive agricultural robot that meets predefined requirements, focusing on adaptability to different agricultural scenarios; (2) build the robot according to the established design concepts to ensure structural integrity and operational feasibility; (3) design algorithms to enable the robot to perform basic autonomous and intelligent tasks, including but not limited to obstacle avoidance and automatic gait transformation, enhancing its functionality in dynamic environments; and (4) evaluate the robot's operational efficiency in agricultural environments and gather empirical data and insights to inform advances in more complex functions such as autonomous navigation and robot clustering strategies.

### 2 System Overview

The robotic system designed in this study is based on bionic principles, which offer superior dexterity, robust load capacity, and the ability to adapt to complex agricultural terrains. The system's overall architecture integrates three core subsystems: a sensing system (Section 3.3), a control system (Section 3.4), and a motion system (Section 3.5). Each has been specifically designed to improve the efficiency and stability of the robot in agricultural environments. Example specifications are given in Table 1.

TABLE 1
Example Specifications of the Robot

| TYPE | DESCRIPTION |
|---|---|
| Mass | 4.2 kg (without battery, 4.7 kg (with 2 batteries) |
| Dimension | Diameter: 1.21 m (expanded), 0.77 m (standing), |
| | Clearance: 6-18 cm |
| Power Supply | Two 3S LiPo battery (11.1 V, 5200 mAh) |
| Traveling Speed | Up to 1.2 m/s |
| Payload | 8 kg (including batteries and sensors) |
| Endurance (with | 3 hours (standing), 1 hour (traveling at 0.5 m/s) |
| 2 batteries) | |

This disclosure offers a range of optional sensing system configurations to accommodate varying mission requirements and enhance the robot's capabilities. For scenarios necessitating an assessment of the robot's kinematic performance, one embodiment of the robot with IMU and force sensors was equipped to record comprehensive data on the robot's attitude and motion dynamics. Accordingly, in some examples, this disclosure employs an advanced example of the robot for scenarios that utilize autonomous navigation, with an additional environmental sensing module. This module integrates multiple sensors, including LIDAR, distance sensors, and cameras, to acquire real-time data on ground conditions and potential obstacles. Such data is pivotal for enabling autonomous navigation and obstacle avoidance, thereby facilitating the robot's efficient operation across diverse agricultural environments. In the control system, the signals from the sensors are analyzed by the data processor to generate the robot's motion parameters such as the angle each joint needs to rotate, the robot's motion speed, and the direction of motion according to predefined algorithms. The motion controller then generates Pulse-Width Modulation (PWM) signals recognizable by the motion system based on these parameters according to a written algorithm. The function of the motion system is to precisely regulate the angle, rotational speed, and torque of the servos according to the commands given by the control system. This regulation ensures that the robot moves at a predetermined trajectory and speed. With these three systems integrated, the robot can overcome the challenges encountered in complex agricultural scenarios.

To accommodate obstacles of different heights in the field, a notable feature of this robotic system is its ability to switch motion modes between high clearance and low clearance. This feature enhances its adaptability for plants at different growth stages and enables it to move efficiently by changing its clearance to cross obstacles of varying heights. The robot can operate in various environmental conditions, from flat terrain to sloping terrain and terrain with various obstacles.

### 3 Hardware Design

### 3.1 Hardware Design Examples

Since some of the application scenario of the robotic system is agricultural tasks, parameters such as weight, endurance, traveling speed, and payload of the robot need to be considered. Therefore, the following performance parameters are used to guide the hardware design.
1. Lightweight. Agricultural robots are characterized by lightweight and flexible movement compared to large machines such as tractors. Currently, most agricultural robots weigh between 5 and 800 kg. For legged robots, due to their simple structure and small size, their weight is on the small side, between 1 and 20 kg. Therefore, the goal is to ensure that the maximum weight should not exceed 10 kg while maintaining the strength and stability of the robot.
2. Endurance. The endurance time of a robot is mainly determined by the battery capacity and the power of the robot's motion and control system. Existing legged robots have an endurance from 2 to 12 hours. Therefore, the minimum endurance can be no less than approximately 2 hours.
3. Traveling speed. Agricultural robots often do not need to travel at high speeds because the task asks them to be highly accurate. Most current agricultural robots travel at a speed between 0.5 and 3 m/s, and the proposed design can have a maximum speed range from approximately 0.8 to 1.5 m/s.
4. Payload. The robot can have enough payload to carry one or more hardware modules. Although the payload depends on the different mission requirements, the robot at this stage should be able to carry at least equipment such as sensors, cameras, and LiDAR. Thus, the load should not be less than approximately 8 kg in various embodiments.

### 3.2 Body Design

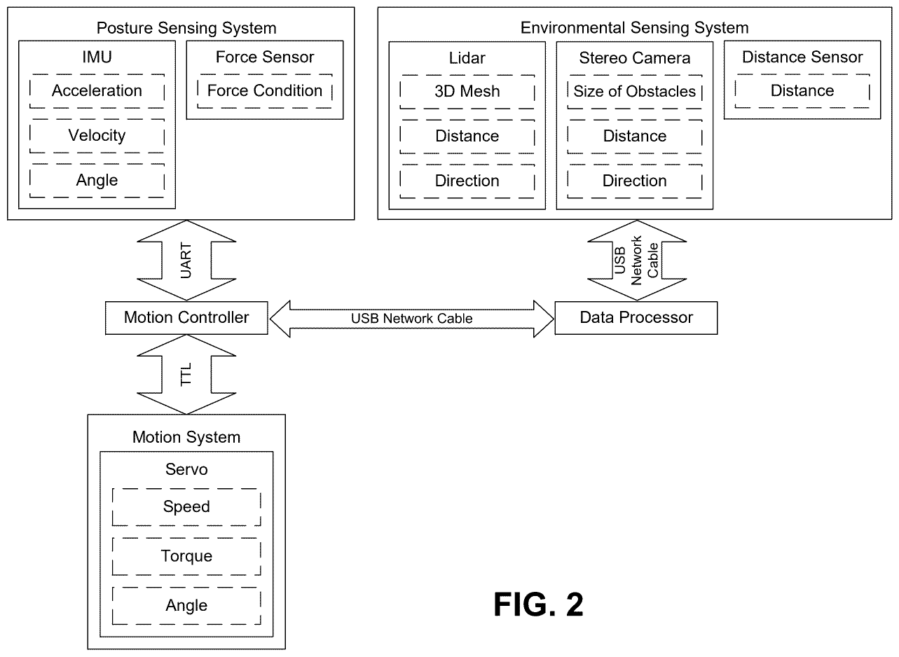

Inspired by the versatile locomotion capabilities of insects in unstructured environments, the robot can feature six highly flexible legs, each with three degrees of freedom. This design allows the robot to mimic the complex movements of natural creatures. Additionally, the robot's architecture is modular, allowing for the flexible integration of various sensors based on specific operational requirements. This adaptability enhances the robot's utility in different tasks and environments. FIG. 1A is a CAD model of the standard example of the robot, depicting one example of the structure of the components of the robot and showing the arrangement of the bionic legs and core components. The example illustrated in FIG. 1A depicts a robot with an IMU and force sensors for recording robot attitude and motion information. FIG. 1B shows the design of another example of the robot, including additional hardware such as range sensors, stereo cameras, and a data processor with higher computational power. The stereo cameras are used to generate depth images and are paired with distance sensors mounted on the second base plate. FIG. 2 shows the structure of the hardware system. In one example, the hardware system contains a posture-sensing system, an environmental sensing system, a motion system, and two controllers. The following subsections delve into the hardware design requirements and provide detailed descriptions of the design and function of each robot component.

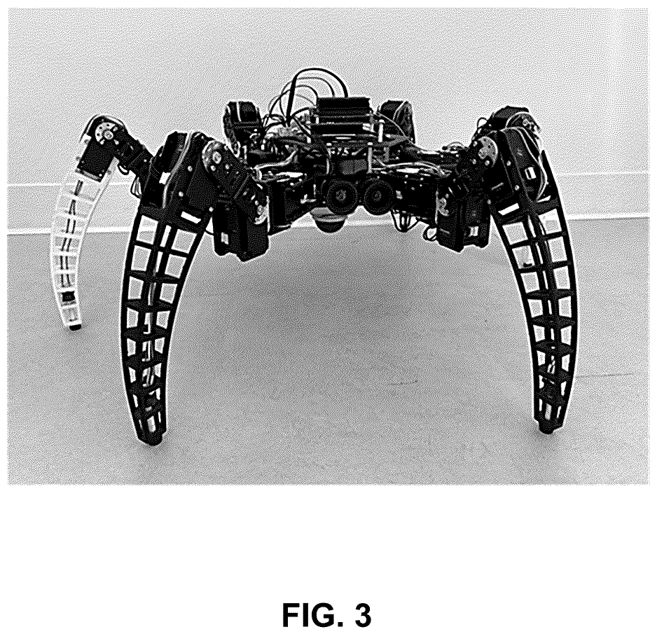

The frame of the robot body (FIG. 3) is used to support the robot's overall structure and connect to other systems. The frame is rigid, and two significant criteria were considered in its design. The first criterion is the frame's ability to withstand the robot's total weight, and the stresses generated by the robot in motion. The second criterion is that the frame should be lightweight, and the weight of the frame should be minimized while maintaining stability to increase the load capacity of the robot. Based on the above design concept, carbon fiber, known to have excellent strength-to-weight ratio and rigidity, was used as the material for one example of the base plate of the robot body. The design also features a double-layer construction with six nylon struts in the center for support. This design increases the available space within the fuselage and provides enhanced resistance to bending moments. The frame is divided into three layers by a double-layered base plate, allowing the user to configure the frame with the mission's requisite sensing and control systems. After experimental trials, the thickness of the base plate was selected to be 2 mm to ensure high stiffness and low weight.

### 3.3 Sensing System Design

This disclosure develops a posture sensing module for both the standard and advanced examples of the robot for real-time monitoring of the robot's posture and motion status during movements. This configuration enables the robot to dynamically adjust its motion strategy based on the posture data and maintain balance by continuously evaluating its own posture. For the advanced examples of the robot, this disclosure introduces an additional environmental sensing system for robot perception. This system enables the robot to detect variations in the surrounding terrain and autonomously plan an appropriate path of travel, thus enabling the robot to perform advanced tasks such as autonomous navigation and obstacle avoidance.

### 3.3.1 Posture Sensing System

The posture sensing system comprises a nine-axis IMU (LORD, Cary, NC, USA) and six force sensors mounted on each leg. The IMU measures the robot's inclination, angular velocity, and angular acceleration in pitch, yaw, and roll directions, which are used to provide feedback on the current robot posture. The force sensors are mounted at the end of each leg, and the robot's gait algorithm stops when the force sensors detect that the leg has touched the ground. The force sensor changes its resistance under external pressure, and the controller reads the voltage of the sensor to determine whether the robot's foot touches the ground or not. This design addresses the situation where part of the leg hovers above a groove when the robot crosses it, preventing potential falls.

### 3.3.2 Environmental Sensing System

The environmental sensing system is realized by interacting with a LiDAR (LIVOX, Shenzhen, Guangzhou, China), three Red-Green-Blue (RGB) cameras (FLIR, Wilsonville, OR, USA), and three range sensors (Benewake, Beijing, China). LiDAR provides detailed spatial data and precise ranging information with high accuracy and long-range detection capability. However, the large amount of data generated by LiDAR can utilize high computing power and is weather-sensitive. In this case, 3D cameras are complementary and can provide better depth perception of the scene with faster computation. In addition, the distance sensor, with its low cost, small size, and high efficiency, can provide instant distance measurement, which is especially effective for obstacle avoidance and essential object detection. This multi-sensor fusion approach optimizes the sensing system's overall performance, providing more robust solutions in various environments and application scenarios.

The effective detection range of the LiDAR is a cylindrical space with a diameter of 20 meters, with the installation height as the upper surface, excluding a cone with a top angle of 32°. The bottom surface of this cone does not exceed the projection of the base plate on the ground, so the LiDAR's detection range is extensive enough for the robot. The camera used in this study features a diagonal field of view (FoV) of 94°, a horizontal FoV of 82.9°, and a vertical FoV of 66.5°. The base plate of the robot's basic version was designed with three sets of camera mounting slots, each vertically offset downward by 20°. Additionally, the angle between each set is 60°. This arrangement enables the integration of the three camera sets to create a semi-panoramic image of the robot's surroundings. This composite imaging capability facilitates the precise identification and labeling of obstacles and distinctive terrain features, enhancing the robot's operational effectiveness in diverse environments. The range sensor has a measurement range of 20-200 cm and is used in conjunction with the LiDAR and cameras for obstacle detection.

### 3.4 Control System Design

The control system comprises a motion controller and a data processor. The motion controller is the OpenRB-150 (ROBOTIS, Lake Forest, CA, USA), which supports programming with the Arduino IDE, according to various examples. Since the robot needs to process images and point cloud information generated by the camera and LiDAR, the amount of data is quite large and can utilize a processor with high computing power. Therefore, the Jetson nano (NVIDIA, Santa Clara, CA, USA) can be used in one example, which is lightweight and has high computational power for applications that utilize real-time processing of complex algorithms in the field.

### 3.5 Motion System Design

The design idea of the motion system is to form a leg with three servos and three connectors. The servo in the hip joint has horizontal rotational degrees of freedom to control the forward and backward motion of the leg. The knee and ankle joints are equipped with servos with vertical rotational freedom to control the up-and-down motion of the leg. Since the design goal of the robot is to cross potential obstacles in agricultural fields, the legs are designed as a support bar with a 27 cm long support rod with a 30-degree curvature to cross obstacles more easily. The servos used are Dynamixel MX-106T (ROBOTIS, Lake Forest, CA, USA), which has a rated voltage of 12 V and a rated torque of 8.4 N·m. This high-performance servo provides powerful torque to increase the robot's payload. The connecting parts that utilize high strength are made of aluminum alloys using CNC machining methods, and the non-stressed parts are manufactured using 3D printing technology. An example, exploded view of the entire leg is shown in FIG. 4 where the leg is shown to contain three servos, a 3D-printed leg skeleton, pressure sensors, and rubber pads to increase friction.

### 4 Locomotion Model

This disclosure developed a Terrain-Adaptive gait (TA gait) based on the traditional tripod gait to optimize the robot trajectory. Previously commonly used robot motion control is usually optimized with a fixed clearance. In agricultural applications, this gait is not well adapted because of the inconsistent heights of obstacles. In contrast, the proposed terrain-adaptive gait enables the robot to vary its clearance to cross the barriers more efficiently and with less energy. Thus, it is more suitable for applications in agricultural scenarios.

### 4.1 Locomotion Control

The TA gait is categorized into two modes. The first mode is a marching mode with lower clearance and lower energy consumption (FIG. 5A), while the second mode is a step-over mode with higher clearance (FIG. 5B). The a and b in FIGS. 5A and 5B, respectively, represent the clearance of the robot in these two modes, which are 6 and 18 cm, respectively. Both modes combine three basic motions of the robot's single leg, and these motions include striding motion, dragging motion, and clearance change motion. Striding motion is the process of lifting the leg from a decent position, moving it to the target position and then stepping back to the ground. Dragging motion is defined as the process in which the leg stays in contact with the ground and pulls the robot's body forward by friction. As the robot moves, its six legs repeat the striding and dragging motions at intervals to ensure that at least three legs are in contact with the ground at any given moment and that the center of gravity of the robot falls within the area formed by the contact points. The logic flow of the robot in accomplishing the task is shown in FIG. 6.

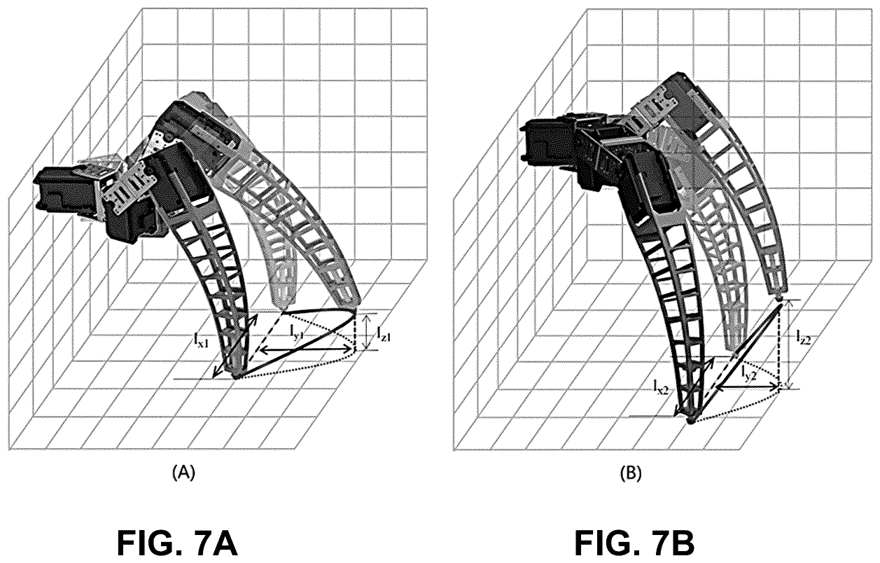

The marching mode of this robot includes a leg-spanning motion and a dragging motion. During the spanning phase, the robot's foot is lifted and moves along an arc on the sagittal plane, transitioning from the rear pole position to the front pole position. On the other hand, the drag motion involves the robot's body being propelled forward through friction while the foot maintains contact with the ground at the front pole position. The robot advances one step forward by completing two sets of spanning and dragging motion cycles. The leg movement process and foot trajectory 3D plot for the marching mode and step-over mode are shown in FIGS. 7A and 7B.

The step-over mode of the robot is similar to the marching mode, but the knee servo has an angle that is greater than 90° and a larger clearance. The ankle joints are contracted inward during the movement, so more considerable obstacles can be crossed. FIGS. 7A and 7B depict the trajectory of the end of the legs as it takes a step.

In FIGS. 7A and 7B, Ix1, Ix2 represent the forward distances, ly1 and ly2 denote the lateral extension distances of the foot, and Iz1 and Iz2 indicate the height of the leg lift. In the marching mode, each leg is rotated at an angle of 30°, and the height of the leg lifted is a fixed value of about 3 cm, so that the foot trajectory projected on the ground is a minor arc with an angle of 30° and a radius of the length of the leg contracted up. FIG. 7A shows the trajectory of the end of the leg in marching mode and FIG. 7B shows the trajectory of the end of the leg in step-over mode.

In the step-over mode, the angle of rotation of each leg and the height of lifting depends on the size of the obstacle, and the value of each parameter can be inverted by the foot trajectory. According to the present disclosure of the robot, the trajectory is set as a minor arc that precisely envelopes the obstacle.

### 4.2 Leg Trajectory Control Model

In this example, leg trajectory control is optimized based on the traditional tripod gait algorithm. Traditional trajectory control, such as pendulum trajectory control, requires computing the landing point of the robot's foot end at each step and using inverse kinematics to control the angle of each servo. This approach generates many complex computations, requires long computation time and energy consumption, and is not conducive to the longer endurance required in agricultural scenarios. Furthermore, the end of the foot makes a greater angle contact with the ground, resulting in a more profound impact. Therefore, this disclosure proposes a computationally efficient trajectory control algorithm. Previous studies have explored similar curve-fitting and periodic oscillation control methods and validated their effectiveness in achieving adaptive motion. Building on these fundamental studies, the approach introduces gait switching and adjustable robot spacing, addressing the problematic leg of previous gaits that cannot adaptively cope with obstacles of different heights.

The following equations define the trajectory control of the robot leg:

$${θ}_{i 1} = {θ}_{i 1}^{0} + {l}_{1} sin ( 2 t ) \qquad ( 1 )$$

$${θ}_{i 2} = \{ \begin{matrix}{θ}_{i 2}^{0} + \frac{1}{2} {l}_{2} [ cos ( 4 t ) + 1 ] & if cos ( 2 t ) > 0 \\ {θ}_{i 2}^{0} & otherwise\end{matrix} \qquad ( 2 )$$

$${θ}_{i 3} = \{ \begin{matrix}{θ}_{i 3}^{0} + \frac{1}{2} {l}_{3} [ cos ( 4 t ) + 1 ] & if cos ( 2 t ) > 0 \\ {θ}_{i 3}^{0} & otherwise\end{matrix} \qquad ( 3 )$$

where θᵢ₁ is the angle of the hip servo, θᵢ₂ is the angle of the knee servo, and θᵢ₃ is the angle of the ankle servo. The letter i identifies which leg of the robot this is. Symbols with a superscript of 0 represent the angle of each joint at initialization (moment t=0). The symbols I₁, I₂, and I₃ indicate the angle of the hip, knee, and ankle joints need to be rotated. These parameters can be solved by the kinematics mentioned in section 4.1. Specifically, they can be solved by forward kinematics (Equation 4) and inverse kinematics (Equation 5):

$$[ \begin{matrix}x \\ y \\ z\end{matrix} ] = [ \begin{matrix}sin {l}_{1} & cos {l}_{2} sin {l}_{1} & cos {l}_{3} sin {l}_{1} \\ cos {l}_{1} & cos {l}_{2} cos {l}_{1} & cos {l}_{3} cos {l}_{1} \\ 0 & sin {l}_{2} & - sin {l}_{3}\end{matrix} ] [ \begin{matrix}a \\ b \\ c\end{matrix} ] \qquad ( 4 )$$

$$\{ \begin{matrix}{l}_{1} \approx {sin}^{- 1} ( \frac{x}{\sqrt{{x}^{2} + {y}^{2}}} ) \\ {l}_{2} \approx {sin}^{- 1} ( \frac{z + c sin {l}_{3}}{b} ) \\ {l}_{3} \approx {sin}^{- 1} ( \frac{b sin {l}_{2} - z}{c} )\end{matrix} \qquad ( 5 )$$

where x, y, z represents the position of the foot landing point in the forward direction, horizontal direction and vertical direction respectively. Letter a, b, c indicate the distances between the hip and knee joints, the knee and ankle joints, and the ankle and the foot respectively.

The value cos (4t) denotes the frequency of joint rotation, embodied in the period of the robot motion, which is the velocity. The value cos (2t) determines the rotation mode of the robot's knee joint. The equations consider the joints' initial angle, rotational speed, and the time-dependent sinusoidal modulation factor. When cos (2t) is positive, it indicates that the leg is still in the forward-spanning phase. Otherwise, it indicates that the foot has moved to the anterior and posterior poles and should be in the dragging mode. Various motion modes can be achieved by adjusting the algorithm variables. To achieve stable movement in a straight line of the robot, the rotational directions of adjacent hip joints are set to alternate in opposite directions, and the rotation of the knee joints has a phase difference of half a cycle to maintain dynamic balance. The robot can also be oriented by rotating the hip joints in the same direction. When a passable obstacle is detected, the robot automatically adjusts the height of the base to ensure effective passage. During clearance elevation, the leg servos follow the following dynamics equations:

$${θ}_{i 1} = {θ}_{i 1}^{0} \qquad ( 6 )$$

$${θ}_{i 2} = {θ}_{i 2}^{0} + \frac{Δ y}{T} sin [ \frac{1}{2 T} ( t - {t}_{0} ) ] \qquad ( 7 )$$

$${θ}_{i 3} = {θ}_{i 3}^{0} + \frac{Δ z}{T} sin [ \frac{1}{2 T} ( t - {t}_{0} ) ] \qquad ( 8 )$$

where Δy and Δz refer to the angle of the knee and ankle joints that need to be rotated, T refers to the period of the robot traveling further, and to refers to the moment at which it starts lifting the ground.

The algorithm's complexity can be significantly reduced by using the sinusoidal modulation factor and time as inputs to the motion function. Compared to traditional robot motion algorithms such as tripod gait, this approach eliminates the need for inverse kinematics to compute the position of the leg, thus allowing faster and more efficient computations.

### 5 Experiments and Results

The TA gait allows the robot to adaptively adjust its base height, enabling it to directly cross obstacles by lifting the base instead of navigating around them. Consequently, in complex environments, robots employing the TA gait complete tasks more quickly and efficiently than those using traditional algorithms. To verify this, simulations and field tests were conducted to assess the stability of the robot's motion in various terrain types. Additionally, field tests were carried out to evaluate energy consumption.

### 5.1 Performance Criteria

The dimensionless cost of transportation (CoT) is a widely used metric for evaluating the energy efficiency of ground robots. It is defined as:

$$C o T = \frac{UI}{mgv} \qquad ( 9 )$$

$$\overline{CoT} = \frac{\frac{1}{T} {\sum }_{i = 1}^{n} {U}_{i} {I}_{i}}{mg \frac{Δ x}{Δ t}} \qquad ( 10 )$$

where U is the battery's voltage, I is the instantaneous current output from the battery, m is the mass, v is the robot's speed, and Δt is the time required to move the distance Δx. The total power consumption calculated by CoT based on the voltage and current of the power supply includes the power of the motors, the power of the data processor, the power of the sensors, and other losses such as friction. It can be seen that energy efficiency is highly dependent on the characteristics of these power-using devices. Since this work calculates the CoT of the same robot in different environments, it is assumed that these power-using devices remain constant during the experiment.

Pitch angle and displacements, which measure the inclination of the robot's body along its longitudinal axis, are used to evaluate the robot's dynamic stability during operations. These metrics can assess the robot's ability to maintain balance and perform effectively across varying terrains.

### 5.2 Simulation Test

Simulation experiments were conducted in Simulink to test the robot's performance on various terrains, including flat terrain with obstacles, sloping terrain, and complex terrain with multiple obstacles and slopes.

### 5.2.1 Simulation Model Configuration

The robot simulation model includes six parts: World Setting, Robot Components, Contact Force, Terrain, Parameter Monitor, and Locomotion Algorithm. The first five parts belong to the physical modeling part, which will be introduced in this section. The Locomotion Algorithm has been introduced in Section 4. The World Setting part establishes the world coordinate system for the robot and defines the ground model. The position of the robot model with respect to the ground is also set here. In the Robot Components section, the robot's six legs are connected to the body by rigid joints, and the dynamics of the three joints of each leg are defined. Contact force contains the force between the robot and the ground and the collision between the robot's own parts. Terrain sections define the position and size of the obstacles in the environment. The parameter monitor can display curves for each parameter of robot dynamics and kinematics over time.

To build the robot simulation model, a 3D model of the robot designed in SolidWorks was used and imported into Simulink through the Simscape Multibody interface. This process enables the transition from static 3D design to dynamic simulation, allowing detailed analysis and refinement of the robot's kinematic dynamics and interaction capabilities in a controlled virtual environment. This approach improves the accuracy of simulation results and provides a suitable framework for iterative testing and optimization of robotic systems.

The world framework block, mechanism configuration block, and solution configuration block can be included in the world setting part. The world frame block was used to define the world origin and coordinate system in the simulation environment. The mechanism configuration block was used to define the physical parameters in the simulation environment, such as gravity was initially set to 9.8 m/s2 in the z-direction, and the solver configuration block was used to control the physical simulation environment. These three components build the complete physical simulation environment. The first component connected to the World setting part is a brick solid block with dimensions of 20 m×20 m×0.01 m, which serves as the ground in the simulation environment. To ensure that the robot can make translational and rotational motions in three different dimensions on the ground, a 6-DOF joint block is connected between the robot model and the ground model. The distance between the robot's coordinate system and the ground was then set using the coordinate system transformation module. The distance between the center of the robot and the ground is 0.25 m.

In the Robot Components section, the relative positions of the robot's body and each leg and the relative positions of each component of the leg are determined from the SolidWorks model of the robot, and the Simscape Multibody plug-in automatically generates the parameters. The simulation model of the robot leg, which comprises three rotating joints and a number of rigid connectors. The three rotational joints allow the leg to rotate in the horizontal plane, around the knee joint in the vertical plane, and the ankle joint in the vertical plane, respectively. In this paper, to control the rotation of the joints, the actuation properties can be set in the revolute joint block, in which the motion is being set to be provided from the output generated by the Locomotion Algorithm and the torque is being calculated automatically.

The subsequent phase of the simulation model configuration entails the integration of the contact force module, which comprises solely spatial force blocks. This module is utilized for the interaction between the robot and its environment. In particular, the spatial force block is connected to the leg model at one end and to the ground model at the other end. This block enables the generation of interaction forces between predefined objects and planes, thus ensuring that the robot model remains stable and does not penetrate the ground in simulation.

Finally, a terrain and parameter monitoring module is incorporated into the model. This facilitates modifying the terrain environment and the real-time recording of pertinent data. The terrain configuration comprises the ground, the objects, and the rigid transformations. Collectively, they define the physical properties of the terrain. The position and angle of objects relative to the center of the ground can be adjusted within the rigid transform. Furthermore, the parameter monitor is designed to track and display dynamic changes in various parameters during the simulation. This is accomplished through parameter outputs, unit conversions, and displays that collectively present the temporal evolution of parameter values.

In summary, in conjunction with the motion algorithms described in Section 4, these elements constitute a comprehensive simulation model of the robot. The model contributes to a detailed understanding of the robot's interaction with its environment and provides a robust framework for further experimental validation and refinement.

### 5.2.2 Moving on Sloping Terrain

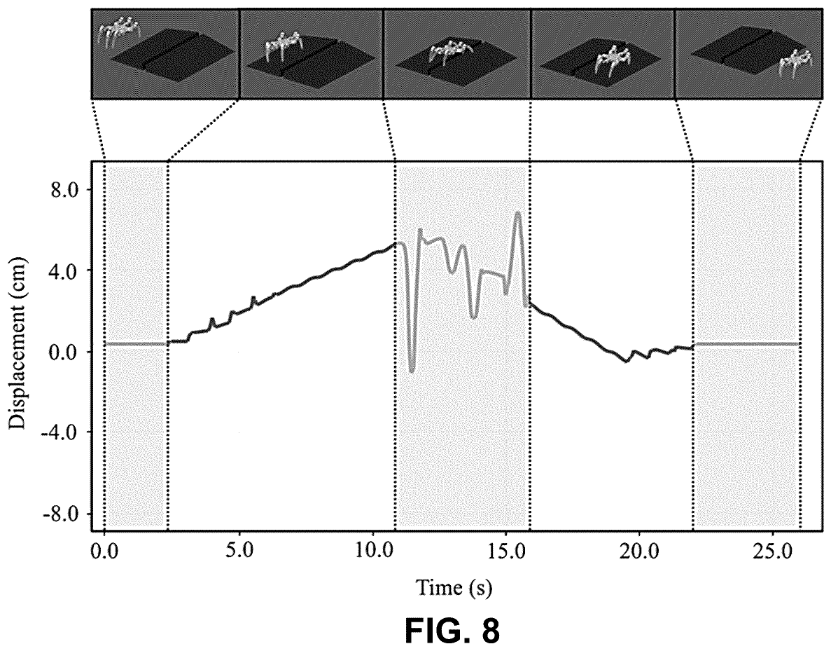

In the simulation environment, slopes with a gradient of 15° were introduced, including uphill, downhill, and a trench, into the terrain portion of the simulation environment. A snapshot of the simulation outcome of the robot navigating these slopes is presented in FIG. 8, which illustrates the vertical displacement of the robot's body as it ascends and descends the slope. It is evident that the robot's vertical displacement remains stable, exhibiting minimal variation along the slope. Moreover, when encountering the trench, despite one leg becoming obstructed and the body being inclined, the robot successfully gets out of the trench and reverts to its original motion trajectory. FIG. 8 illustrates that the robot is capable of traveling steadily through slopes and can extricate itself from a grove with one leg stuck.

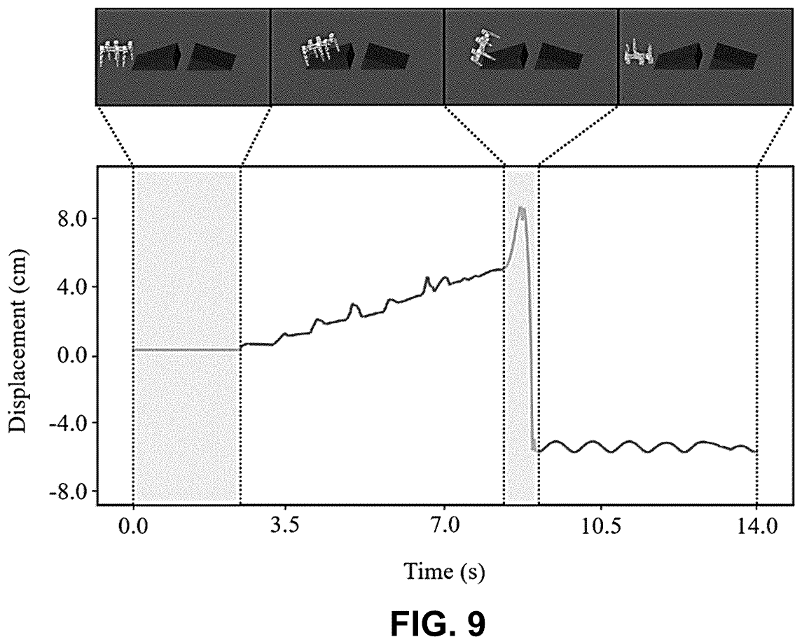

The simulation experiments also included evaluating the robot's stability on various inclined surfaces to determine the maximum slope it could go over. The experimental result shows that at an angle of 17°, the robot encountered stability problems due to its center of gravity moving outside of the tripod stability zone delineated by the contact points. This situation would result in the robot tipping over. FIG. 9 illustrates the fluctuation in the vertical displacement of the robot's body during the simulation. When the slope increases to 17°, the robot gets an unstable center of gravity and flips over.

### 5.2.3 Moving on Terrain with Multiple Obstacles and Slopes

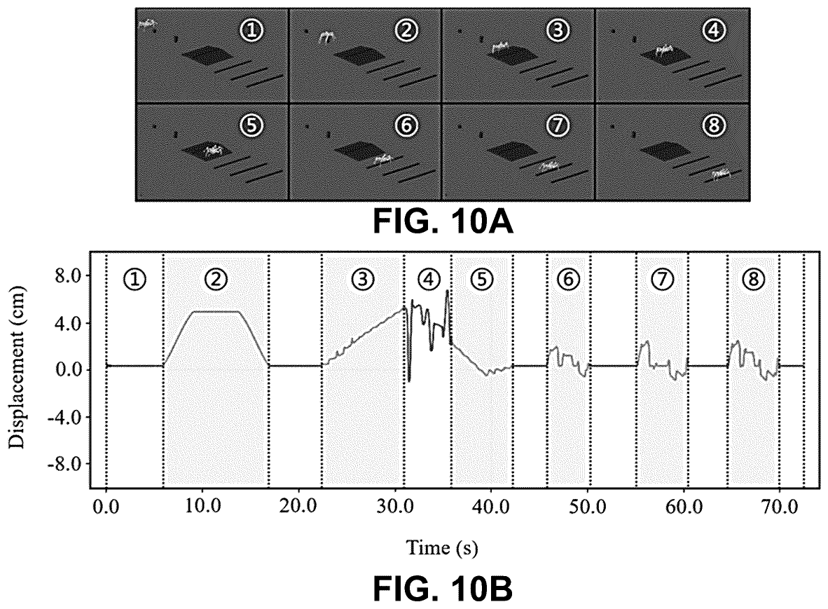

This disclosure added three additional horizontal furrows with cross-sectional dimensions of 6 cm by 6 cm and 80 cm spacing between the furrows to the slope simulation environment in the previous section. A snapshot of the simulation results of the robot passing through the entire terrain is shown in FIGS. 10A and 10B, which shows the vertical displacement of the robot as it passes through the different terrains. FIG. 10A depicts sequential simulation snapshots showcasing a legged robot navigating through a challenging obstacle course with varying terrains and obstructions. FIG. 10B illustrates a graphical representation of the robot's vertical displacement over time, indicating its stability and agility during the obstacle course navigation.

### 5.3 Field Test

This disclosure conducted numerous experiments to evaluate the performance of the previously proposed motion algorithm in terms of energy efficiency and body stability.

### 5.3.1 Experimental Setup

To generate experimental results in different environments, this disclosure prepared four different experimental terrains: flat ground with obstacles, 12° slope, flat grass field, and grass field with obstacles. The robot autonomously moved along a program-predefined route without prior information about the environment using the motion model described in Section 4. The robot's pitch angle was calculated by the IMU installed on the robot at 10 Hz.

### 5.3.2 Experiments on Flat Terrain with Obstacles

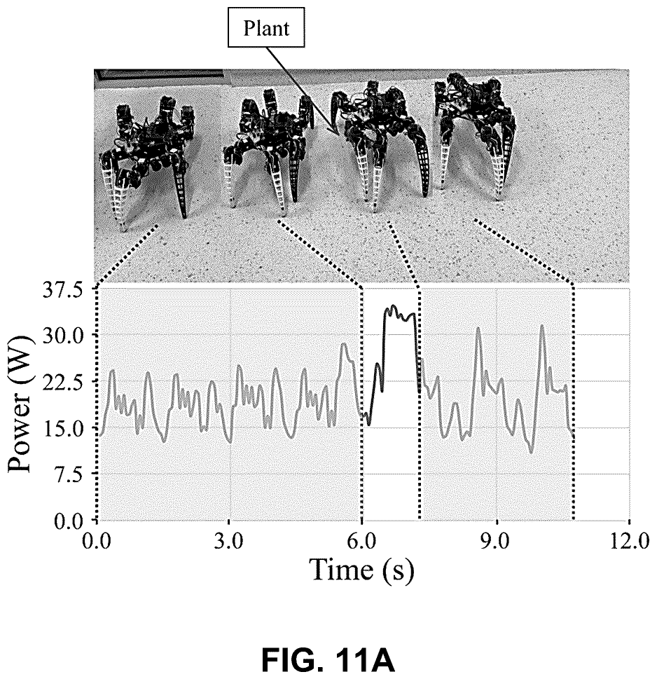

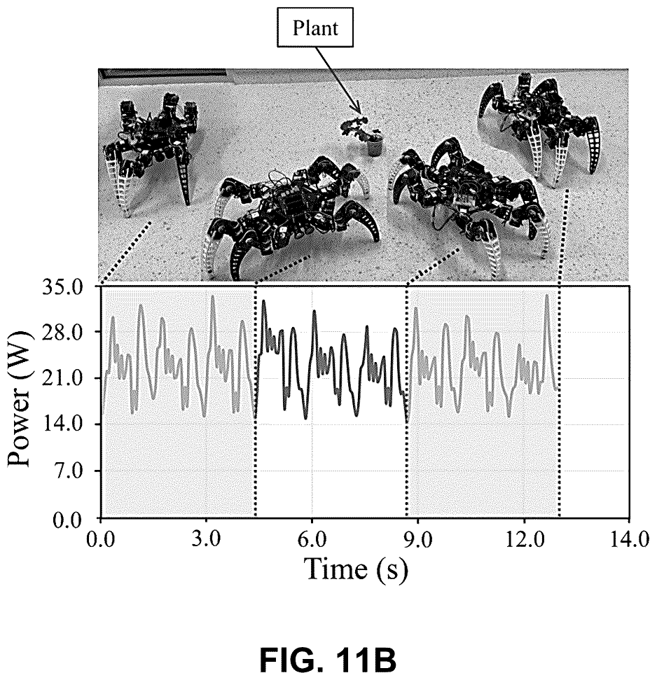

In order to evaluate the robots' motion efficiency and energy consumption, this disclosure conducted controlled experiments. As shown in FIGS. 11A and 11B, the experiments were divided into two groups. The robot was set at the same starting point, one robot executes the traditional tripod gait algorithm to avoid obstacles following the path planned by the artificial potential field algorithm, FIG. 11A, and the other executes the TA gait, FIG. 11B. The disadvantage of the traditional algorithm is that it can only go around obstacles and cannot cross them from above. The robot can cross obstacles by lifting the clearance, thus saving time and energy. The final results demonstrate that the robot in the experimental group executing the TA gait, FIG. 11A) completes avoiding obstacles and reaching the endpoint in only 10.7 seconds, which is 1.8 seconds (14.4%) less than the robot in the control group executing the traditional obstacle avoidance algorithm, FIG. 11B. In FIG. 11B, illustrated is the robot which used a conventional algorithm to avoid obstacles took 12.5 seconds. Furthermore, voltage and current variations were directly recorded during the task, and the average CoT was calculated. The results demonstrated that the average CoT of robots executing the TA gait, FIG. 11A, was 25.3, which was 16.2% lower than that of the traditional algorithm, FIG. 11B, which was 30.2 when obstacles of comparable size were avoided.

### 5.3.3 Experiments on a Slope

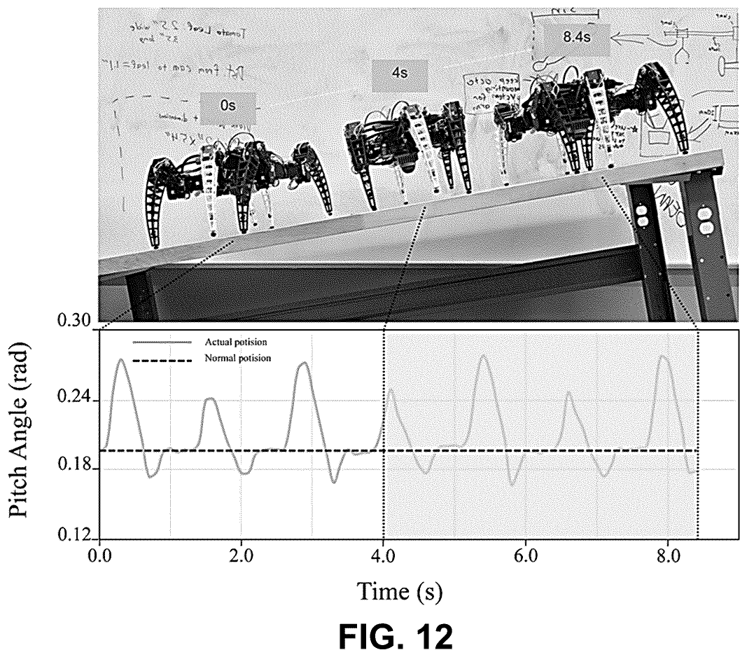

FIG. 12 shows the corresponding pitch angle variation for the robot traveling on a 12° slope. The yellow line represents the average pitch angle changes for the 10 runs. Upon subtracting the slope gradient, the average pitch angle variation ranges from −0.04 to 0.08 radians or −2.3° to 4.6°. The experimental results demonstrate that the robot can maintain stable walking on a slope precisely.

### 5.3.4 Outdoor Experiments on a Grass Field

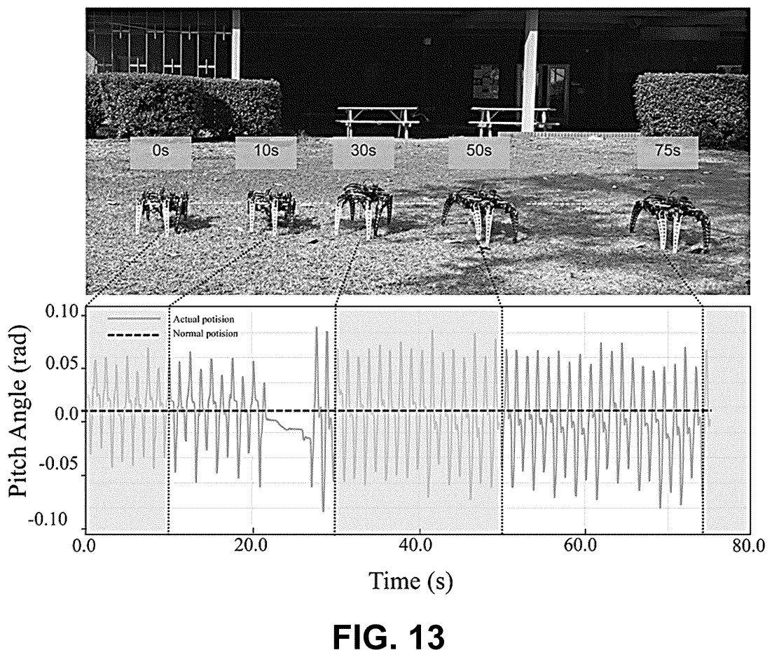

To test the robot's ability to walk on deformable surfaces, a grass field was employed for the test. FIG. 13 shows the corresponding pitch angle variation for the robot walking on the grass. The yellow line represents the average pitch angle changes for the 10 runs. It can be seen that the average pitch angle change ranges from −0.05 to 0.08 radians or −2.9° to 4.6°. The experimental results show that the robot can maintain stable walking on grass with consistent precision.

### 5.3.5 Outdoor Experiments on a Complex Grass Field with Obstacles

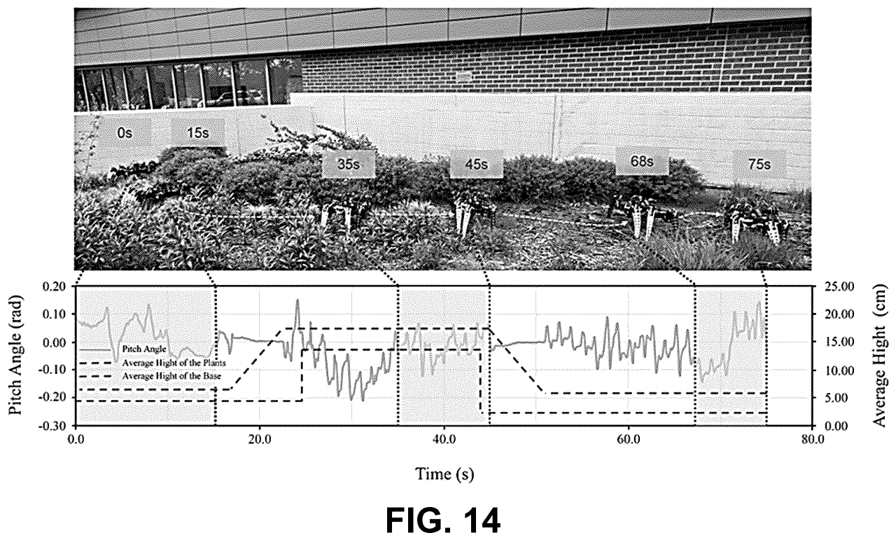

Based on the previous experiment, more complex variations were added, including plants of different heights, curved paths, and sandy and muddy fields with varying soil quality. This environment configuration can better simulate the environment in a real agricultural scenario. FIG. 14 shows the corresponding pitch angle change for the robot traveling through this terrain. The yellow line represents the average of the pitch angle variation over 10 runs. It can be seen that the average pitch angle variation ranges from −0.20 to 0.15 radians or −11.5° to 8.6°. The pitch angle remains relatively constant when the robot raises and lowers the clearance. The experimental results show that the robot could maintain stable walking in the terrain smoothly switched clearance and avoided obstacles with impressive problem-solving skills.

### 6 Conclusion and Future Work

In summary, this embodiment has successfully developed a hexapod robotic system that demonstrates locomotion stability under various environmental conditions. The system has exhibited exceptional performance in both simulated environments and field tests. The main contribution of this robotic system is that it solves the problem that traditional agricultural robots are unable to traverse farmland with a cluttered ground environment. In such environments, crops are highly susceptible to damage. The robot executes terrain-adaptive gait algorithms that can switch motion modes according to different terrains, which enables it to cope with highly complex environments. Additionally, it has adaptive clearance, which allows it to directly cross obstacles without going around them. This disclosure successfully modeled the robot's movement over various terrains in simulation. In real-world tests, the robot performed well on slopes with a gradient up to 17°. The fluctuation of the center of gravity when crossing the obstacles was controlled from −2 cm to 2 cm. Finally, a large number of field tests were completed. On the flat surface, the terrain-adaptive algorithm is more energy efficient than traditional obstacle avoidance algorithms, saving 14.4% of energy consumption for every obstacle crossed. In the tests on grassland, the robot still maintains good stability, with pitch angle fluctuations of only −11.5° to 8.6°. Table 2 provides the mean, standard deviation, and root-mean-square error of the pitch angle of the robot while moving over these three terrains. The robot demonstrates remarkable stability in performance when navigating slopes and grass fields. Specifically, the root means square error (RMSE) of the robot's pitch angle is 1.803° on slopes and 3.559° on grass fields. Notably, even under challenging conditions, such as traversing a complex grass field with uneven terrain and multiple obstacles, the RMSE of the robot's pitch angle remains within an acceptable margin of error at 7.140°. Compared to previous work, the robot can walk stably on slopes with greater angles and with less oscillation on flat and complex terrain. However, there are still some practical problems that need to be solved.

TABLE 2
Mean, Standard Deviation, and Root Mean Square Error
of Pitch Angle for Robot Moving on 12° Slopes,
Grass Field, and Complex Grass Field with Obstacles

| | | Standard | Root Mean |
|---|---|---|---|
| Type of Terrain | Mean/° | Deviation/° | Square Error/° |
| 12° Slope | 12.261 | 1.752 | 1.803 |
| Grass Field | −1.417 | 3.267 | 3.559 |
| Complex Grass Field | 1.580 | 6.968 | 7.140 |
| with Obstacles | | | |

### Example B

### 1. Background

Downy mildew of cucurbits is a global threat to the Cucurbitaceae family of plants. It is caused by the oomycete pathogen Pseudoperonospora cubensis, which produces airborne spores that can travel hundreds of miles and infect more than 60 different plant species. If left unmanaged, this disease can lead to a significant decrease in yield, reduced nutrients, and secondary rot. Traditional detection methods often come too late and can easily be confused with similar diseases. Therefore, a specialized method for accurately detecting airborne spores can be desired.

Currently, there is no effective early detection method for downy mildew of cucurbits. Since the disease is difficult to identify in its early stages, it is usually diagnosed by using a low-power microscope or a dissecting microscope to observe symptoms on the upper side of the leaves and spore formation on the lower side of the leaves. However, this method is time-consuming and laborious for large-scale crops, as it involves sampling at different locations and confirming the presence of the P. cubensis pathogen by examining the spore sacs and pigmentation.

To address this issue, a spore trap that does not use leaves to collect effective spores has been developed in various embodiments of the present disclosure. An impact sampler that uses inertia to collect particles from the air has become a promising solution. These samplers redirect the airflow to bypass the surface of solid or agar coating to separate particles and deposit them onto a surface. Generally, the surface is coated with an adhesive to ensure particle adhesion. There are various types of impact samplers available, including the slit impactor for total spores, the rotating arm impactor for total spores, and the sieve impactor for culturable fungi. Although impact samplers are widely used and can effectively collect particles in the air, there are some limitations, such as they are not suitable for collecting certain types of particles, such as those that are too small or too large to be effectively separated by the impactor.

To achieve this goal, various embodiments of the present disclosure used an Arduino-controlled spore trap system, which includes a ducted fan, a 3D printed hood, a sticky collection rod, an electronic speed controller, and a Bluetooth module (HC-06), according to various examples of the present disclosure.

Downy mildew of cucurbits can lead to a significant decrease in crop yield, posing a serious threat to global food security. Early detection and prevention of such diseases are important for ensuring food security and sustainable agricultural production. The newly introduced device can help farmers and researchers to detect the disease in its early stages, enabling them to take necessary measures to prevent its spread and minimize the damage.

### 2. Description of Various Embodiments of the Present Disclosure

### 2.1 Materials

The spore trap system is an electronically controlled system that uses an electronic speed controller (ESC) to regulate the speed of the fan. According to various examples, the ESC is connected to an Arduino board, which provides the control signals to the ESC. Ducted fan construction is a fan designed to produce convergent airflow, significantly increasing speed and pressure, drawing air through the wind collection lid. The lid is designed to accelerate and trap the surrounding air so that the spores can be collected by the adhesive collection rods. The design of the lid optimizes airflow and increases the suction efficiency of the device. The sides of the lid come with a battery powered compartment, an ECS (electronic speed control) compartment and a Bluetooth module compartment. Also attached to the bottom of the lid is a removable 3D printed rods placement compartment via screws. This is used to secure the rods to the bottom of the spore trap. HC-06 Bluetooth module for remote control of the device. The HC-06 Bluetooth module is used to remotely control the device. It is connected to the Arduino board, which provides control signals to the module. With the HC-06 module, the device can be controlled wirelessly from a mobile device.

An example of the overall picture of the device is shown in FIG. 15, and the materials according to one example of the present disclosure are shown in Table 3, including an Arduino Nano microcontroller, a ducted fan, a 3D printed wind collector, glued collection rods, and an HC-06 Bluetooth module, a 3S battery, and an ESC.

TABLE 3
Materials for One Example of Installation

| Components | Functions |
|---|---|
| Arduino nano | Control Ducted Fan, pwm |
| Ducted Fan | Powerful Suction |
| HC-06 Bluetooth Module | Wireless Control, 15 m |
| Collection Rods | Spores Attachment |
| Wind Collection Lid | Guide Airflow |
| Glue | Stick Spores |
| 3s Battery | Power |
| ESC | Electronic Speed Controller |

### 2.2 Use Methods

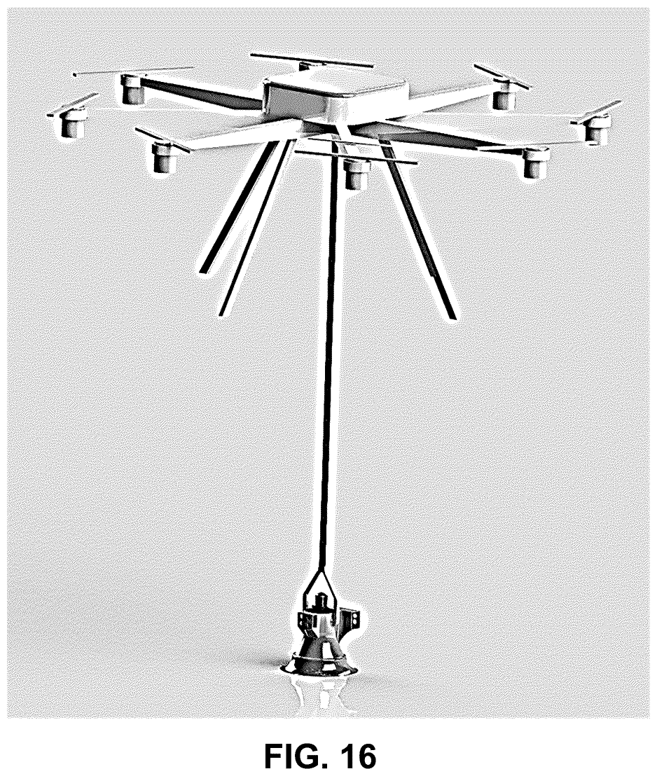

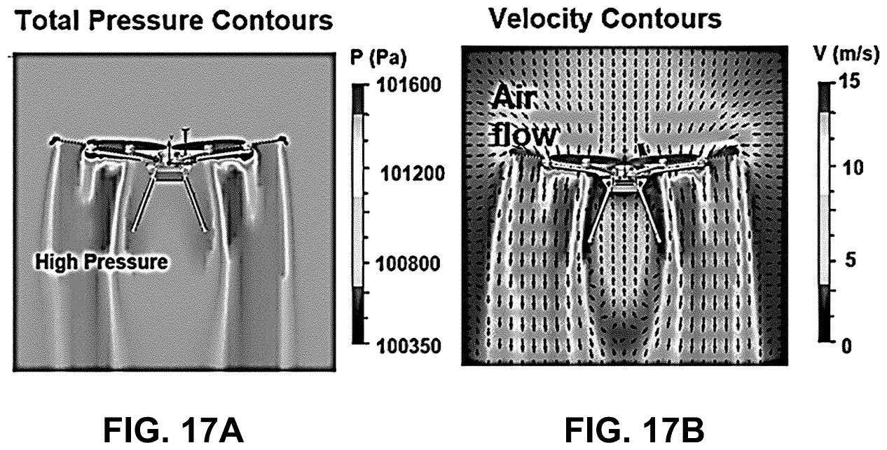

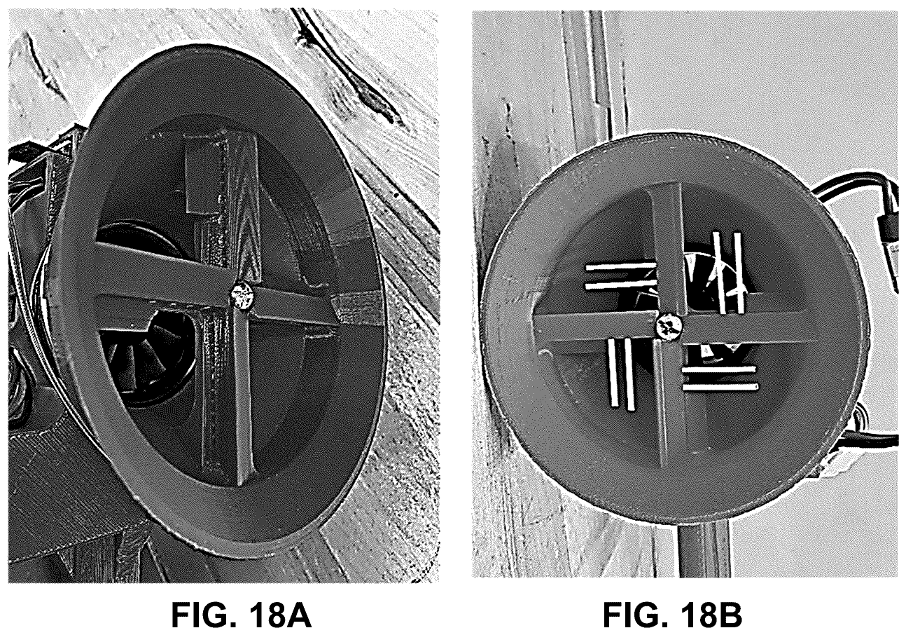

Currently the spore trap system has been successfully tested when used independently or mounted in drones or rovers. The installation method for drones is shown in FIG. 16, where the spore trap is suspended in the air by a drone for efficient spore collection. This method produces a strong and focused airflow, which increases the efficiency of spore collection. The total pressure contours and velocity contours provide a visual representation of the distribution of pressure and velocity around the entire ducted fan. FIG. 17A shows the total pressure contour and FIG. 17B shows the velocity contour. These contours indicate the areas of highest and lowest pressure, as well as the areas where the airflow is the strongest and weakest. By analyzing these contours, researchers can determine the optimal placement of collection plates to maximize spore collection. The system adjusts fan speed to optimize airflow for efficient spore collection. This type of control system ensures that the airflow remains consistent and that the spore collection is as efficient as possible.

As shown in FIG. 18A, the 3D printed rods placement compartment was cleverly screwed to the inlet of the ducted fan to effectively collect the spores. As air is drawn into the ducted fan, it accelerates and is channeled into the wind collection cover, which acts as a nozzle to further accelerate the air and direct it towards the adhesive-coated collection rods. The adhesive glue as shown in FIG. 18B, which on the collection rods is promoted spore attachment to their surfaces, facilitating their collection. By combining the strong suction force of the ducted fan with the guidance and acceleration provided by the wind collection lid, the device is able to effectively collect spores in a controlled manner.

Beyond the use for downy mildew detection, as part of the research that generated the prototype, there is much broader uses of the spore trap according to various embodiments. In agriculture, it could be used for field detection of any airborne pathogen by using the trap as a stand alone, with drones, rovers, attached to a tractor, or using other vehicles. The trap can also be used for air spore sampling in greenhouses, high tunnels, and other protected agriculture structures to monitor pathogen levels in the air. It could also be used in postharvest processing, storage, and shipping facilities to also monitor airborne pathogen levels. Non-agriculture uses would also include particle monitoring in air samples such as pollen or molds, for residential, commercial, healthcare spaces, and environmental air monitoring. The spore trap samples air very efficiently and when combined with either visual spore identification capabilities or molecular diagnostics, would provide different levels of information on an air sample.

### 3. Drawings

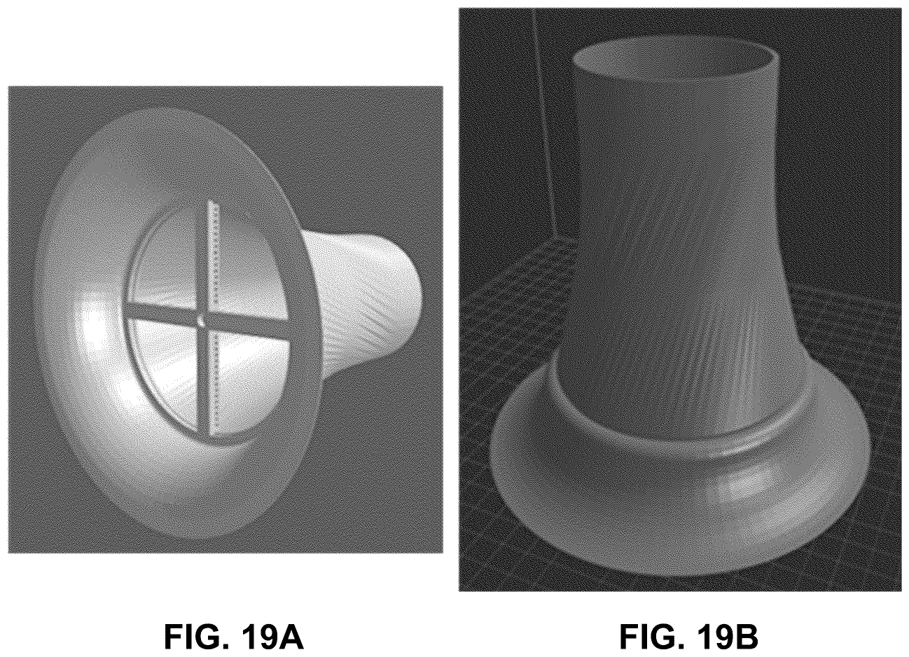

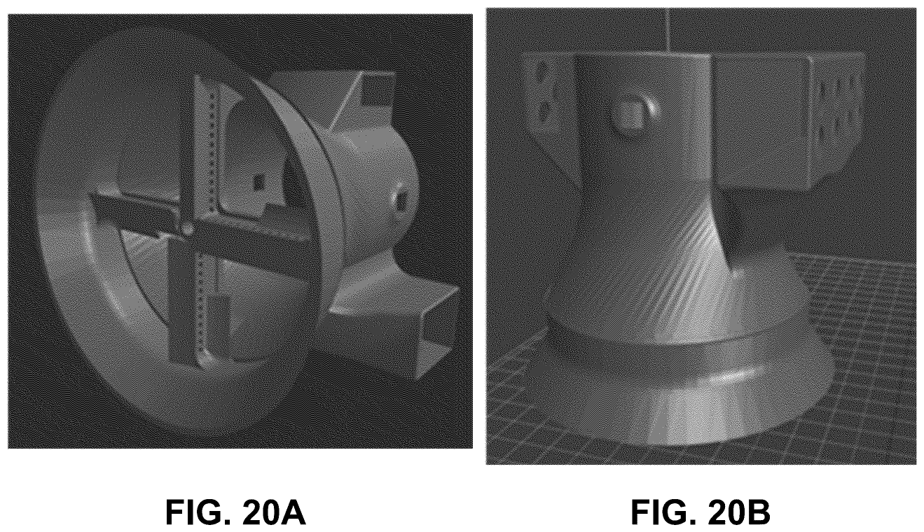

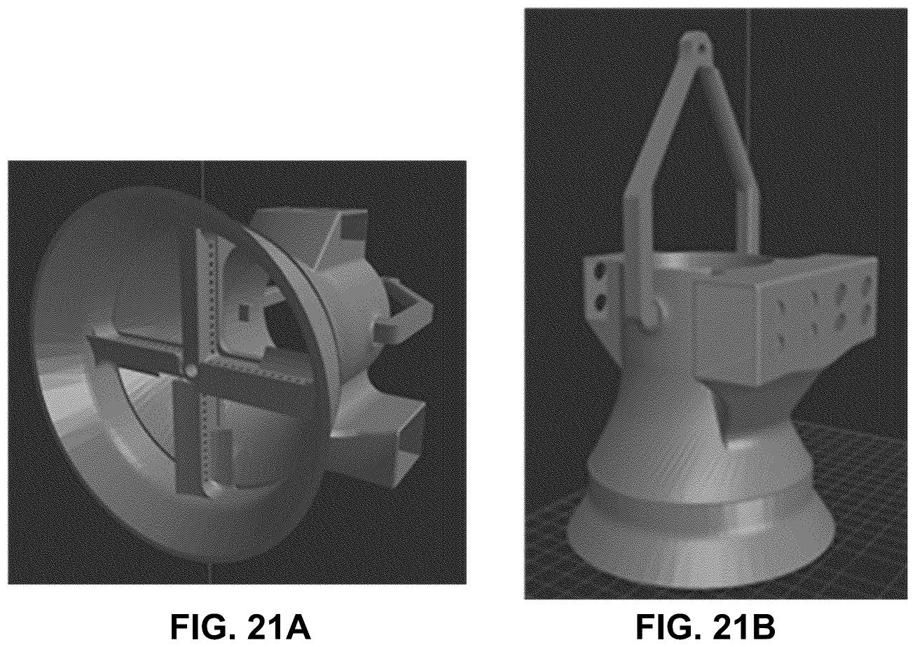

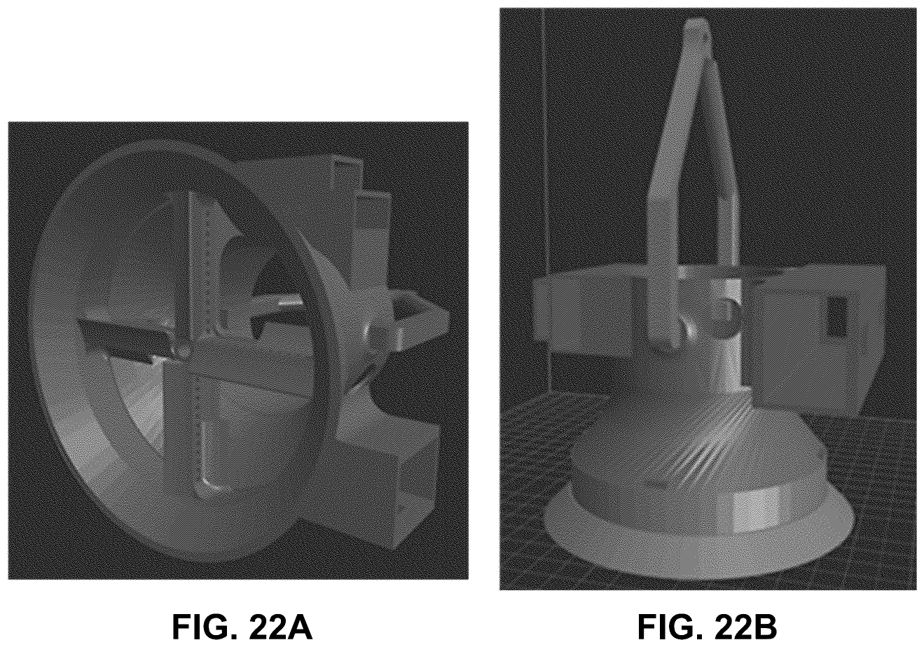

The spore trap system has gone through four iterations, each making the functionality better and the system more stable. The first example is a long tube mounted, which can only be controlled by physical switches, and the rods are mounted in a press and detachable way, connecting the ducted fan and 3D printed wind collection lid by tape, as shown in FIGS. 19A and 19B. In the second example, this disclosure improved the previous example of the very inconvenient switch control through the addition of a wireless module (e.g., Bluetooth) to achieve wireless control, which can be remote controlled through the user interface to switch, and at the same time to achieve the ducted fan speed control, so as to control the suction size of the spore trap system, as shown in FIGS. 20A and 20B. Example 3, a portable handle is added to make it easier to hang on the UAV or cart for operation in the field, as shown in FIGS. 21A and 21B. Example 4, in the actual testing process, this disclosure found that the overall system is too long, resulting in not achieving the best collection effect, by shortening the wind collection lid to increase the collection effect. At the same time, increase the Bluetooth placement bin to avoid the Bluetooth module for a long time outside leading to fault disconnection, as shown in FIGS. 22A and 22B.

### 4. Control

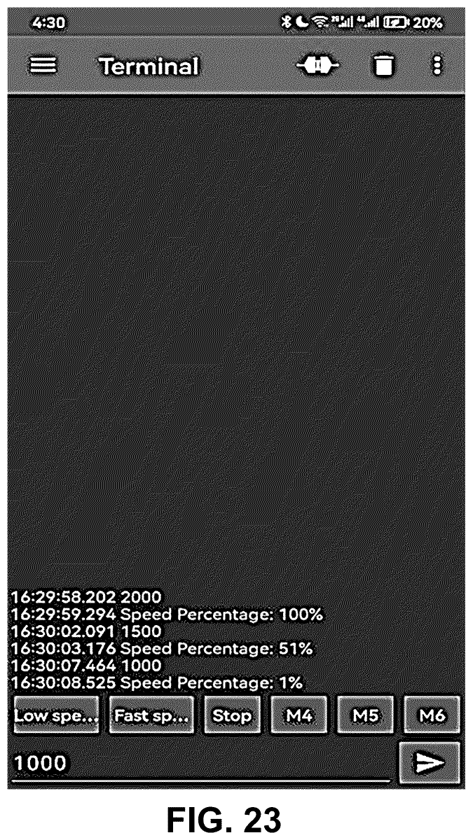

Use Arduino and the corresponding mobile phone software of the Bluetooth module (as shown in FIG. 23). The HC-06 module is an integral device in serial communication systems, primarily serving to transmute Bluetooth signals into serial data, which is then rendered interpretable by the Arduino microcontroller environment. This transmutation process is essential for the operation of the Serial Bluetooth Terminal application, which propels command signals toward the HC-06 module. Subsequent to establishing a connection with an Arduino, the module engages in a pairing process with the application on a smartphone, thereby enabling the reception of command signals encoded as serial data.

The aforementioned application is designed to facilitate the creation of bespoke user interfaces, which grants end-users the capacity to define interactive elements, such as buttons, to initiate specific serial commands. These commands, once actuated by the user, are conveyed to the HC-06 module. For exemplification, the command string ‘1000’ might be programmed to deactivate the whole system, while ‘2000’ could be assigned to maximize the speed of the device. The Arduino's firmware is tasked with interpreting these command inputs to regulate Pulse Width Modulation (PWM) signals. The modulation of PWM can govern the operational dynamics, such as the rotational velocity, of connected motors or fans. The execution of these control instructions is embedded within the ‘loop( )’ function of the Arduino code, which assiduously scans for incoming serial data and enacts the requisite control actions.

For the reception of serial data from the HC-06 module on the Arduino, the codebase typically includes the SoftwareSerial library. This library is particularly advantageous on Arduino boards possessing a single hardware serial port, as it allows for serial communications to be rerouted through digital pins.

The operationalization of the Serial Bluetooth Terminal application in conjunction with the HC-06 module mandates an accurate pairing protocol. Upon the application's installation on an Android smartphone, the user can locate and select the HC-06 from a list of Bluetooth devices. Ensuring efficacious communication entails a synchronization of baud rates across the HC-06 module, the Serial Bluetooth Terminal application, and the Arduino's serial configuration. Successful pairing is visually confirmed through the module's LED indicator, signaling a ready state for the user to initiate command transmission.

### 5. Experimental Test

At the start of the experiment, two groups, Group one and Group two, were created, Group one had a higher initial density (3 g) of colored powder than Group two (1 g).

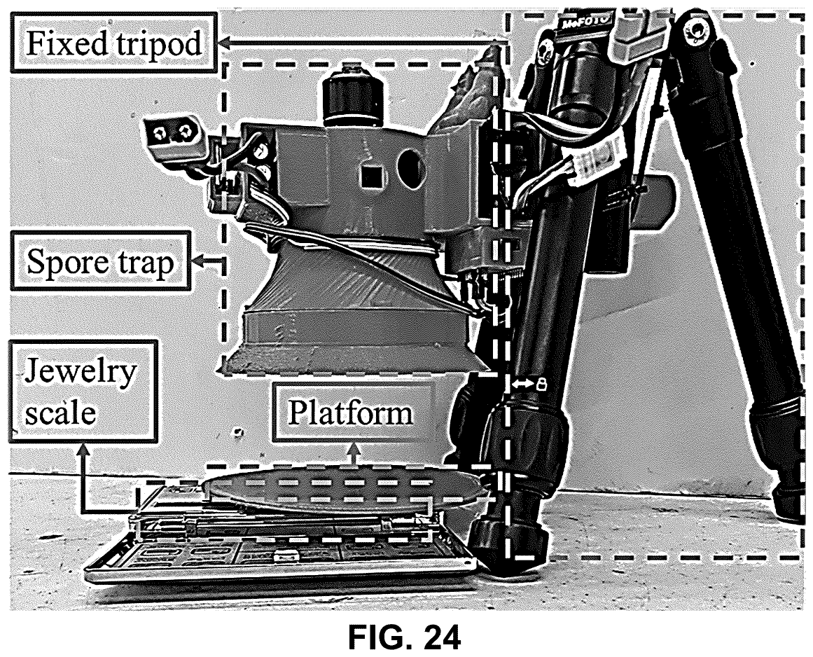

The experimental setup is shown in FIG. 24, where the spore trap is mounted on a tripod at a fixed height, and directly below the spore trap is the platform for placing the colored powders, of which the lowest one is the high accuracy jewelry scale (read out 0.01 g) for weighing. The two sets of accurately measured colored powders (3 g and 1 g) were then subjected to three different wind speeds, i.e., 30%, 50%, and 100% (see Table 4 for experimental groupings). They were evaluated over the same period of time according to the weight of the remaining colored powder on the Jewelry Scale to measure the effectiveness of spore trap in absorbing the spores.

TABLE 4
Experimental Groups

| Group | Speed (%) | Density (High: 3 g/Low: 1 g) |
|---|---|---|
| One | 100 | High |
| | 50 | High |
| | 30 | High |
| Two | 100 | Low |
| | 50 | Low |
| | 30 | Low |

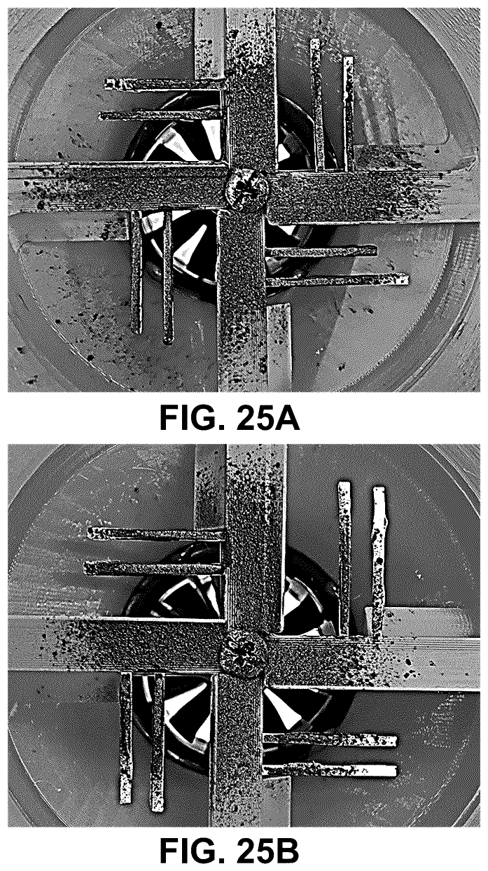

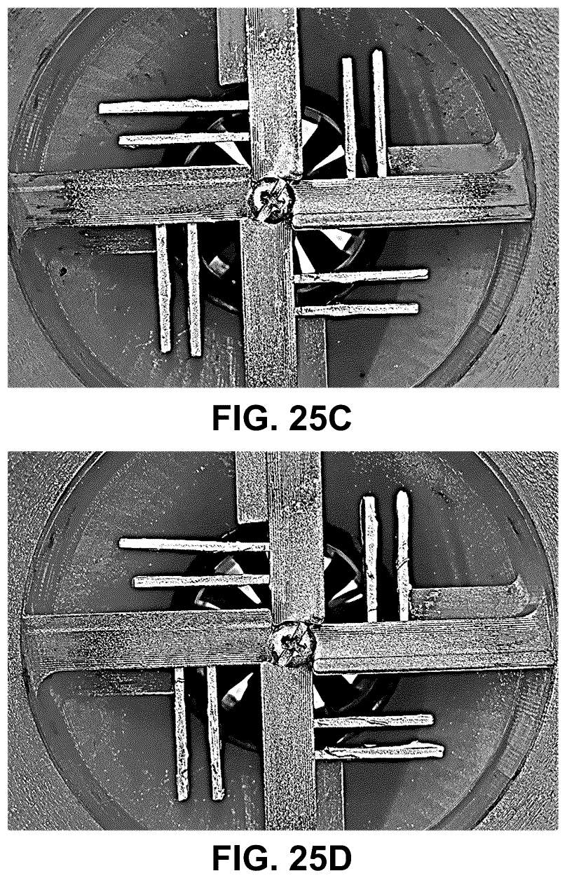

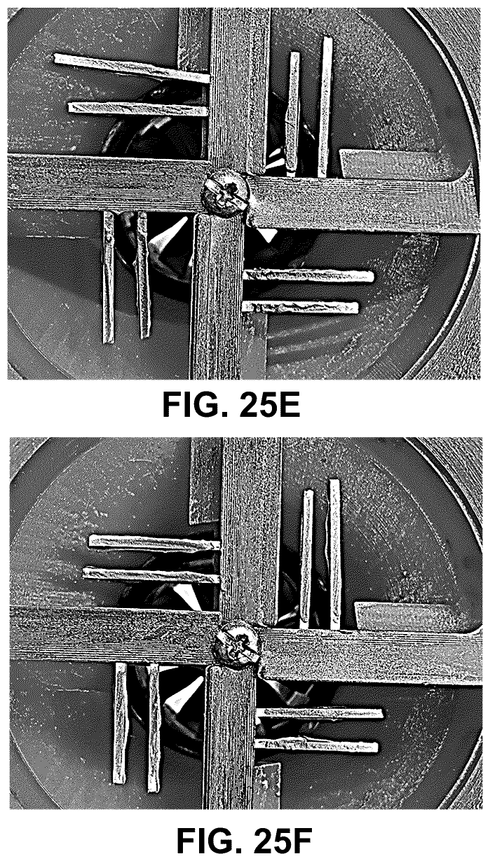

Upon completion of the experiment, the results were analyzed as shown in FIGS. 25A-F and Table 5. Longitudinal within-group comparisons revealed that at a speed of 30%, the coverage of colored powder on the collection bars was significantly lower than at a speed of 50%. However, when the speed was increased to 50%, the coverage was higher as well as at 100% wind speed. A side-by-side comparison of the different powder concentrations shows that at a speed of 30%, the coverage is higher at higher concentrations, but when the speed is increased to 50% or even 100%, the concentration is no longer the main factor affecting the coverage.

Through Table 5, it can be determined that as the speed of the spore trap gradually increases from 30% to 100%, the remaining powder is gradually reduced to no matter what the concentration is, indicating that the increase in speed can enhance the working performance of the spore trap.

The trap was tested for field agricultural uses and evaluated for its ability to capture spores of the cucurbit downy mildew pathogen, in comparison with a traditional roto-rod trap. One-year of experiments revealed that the vacuum spore trap has higher detection events than the roto-rod trap and in a lower sampling time, when combined with a drone. The vacuum trap had similar detection capability to the roto-rod trap when combined with a rover. Experiments will be repeated for another year to confirm detection capabilities.

TABLE 5
Experimental Results

| | | Density (High: | Left Weight |
|---|---|---|---|
| Group | Speed (%) | 3 g/Low: 1 g) | of Power (g) |
| One | 100 | High | 1.86 |
| | 50 | High | 2.41 |
| | 30 | High | 2.80 |
| Two | 100 | Low | 0.60 |
| | 50 | Low | 0.76 |
| | 30 | Low | 0.90 |

### 6. Performance Evaluation

The experiment involved two groups, Group one and Group two, with different initial densities of colored powder. The two groups were subjected to three different wind speeds, 30%, 50%, and 100%, to evaluate the device's spore collection efficiency. The results in FIGS. 25A-F and Table 5. showed that the increased wind speed causes an increase in the suction generated by the spore trap system, resulting in a greater amount of air being drawn through the wind collection lid. This increased airflow allows the apparatus to capture and collect more spores, resulting in a higher coverage rate of colored powder on the adhesive collection rods. The higher wind speed also promotes more even distribution of the spores within the airflow, further increasing the likelihood of spores being captured by the collection rods. Therefore, the device was more effective in collecting spores at higher wind speeds, with 100% wind speed resulting in the highest coverage of colored powder on the collection sticks for both groups.

### Example C

### 1. Introduction

Airborne dispersal enables plant pathogens to travel across fields, regions, and continents, fueling rapid epidemics and emerging disease threats. Biosurveillance, the systematic monitoring of airborne inoculum, offers the opportunity to detect pathogens before symptoms appear and to inform timely, risk-based management. Recent advances in air sampling, molecular diagnostics, metagenomics, and imaging technologies have expanded the scale and resolution of pathogen monitoring, from single-species qPCR assays to community-level aero biome surveys. Integration of biosurveillance data with decision-support systems, remote sensing, and artificial intelligence is transforming early-warning capabilities and providing novel insights into pathogen ecology, evolution, and fungicide resistance. Yet major challenges remain, including assay standardization, data interpretation, and translation into actionable tools for growers. This review synthesizes current approaches, highlights case studies where biosurveillance has advanced disease management, and outlines future directions toward coordinated surveillance networks and precision agriculture applications.

The dispersal of plant pathogens through the atmosphere represents one of the most consequential routes of disease spread, enabling fungal, oomycete, and bacterial propagules to move across fields, regions, and continents. Because aerial dispersal can occur rapidly and often invisibly, outbreaks may appear simultaneously across wide geographic regions, complicating early diagnosis and compressing the time available for intervention. With climate shifts, global trade, and rising fungicide resistance, the urgency for early and proactive detection of airborne inoculum has intensified. Warmer winters extend the survival of inoculum sources, while shifting precipitation patterns alter disease-conducive periods. At the same time, movement of plant material and global supply chains facilitate new disease incursions, turning local problems into global ones. Airborne oomycetes such as Pseudoperonospora cubensis, Plasmopara viticola, Peronospora belbahrii, and Pseudoperonospora humuli exemplify this threat, each causing devastating downy mildew diseases in cucurbits, grapes, basil, and hop, respectively. Similarly, fungal pathogens such as the stripe rust fungus Puccinia striiformis f. sp. tritici in wheat and southern rust (Puccinia polysora) in corn illustrate how airborne spores drive regional epidemics and major yield losses. The magnitude of these epidemics highlights both the vulnerabilities of current agricultural systems and the potential value of biosurveillance to anticipate outbreaks before they cause widespread damage. Biosurveillance, the systematic collection, analysis, and interpretation of biological data, is increasingly recognized as a strategy to mitigate plant disease threats. Unlike traditional scouting or culture-based diagnostics, which often detect disease only after symptoms are widespread, biosurveillance offers the chance to capture inoculum early, when fungicides are most effective if applied preventively or at very low disease levels. However, growers often perceive simple pathogen detection as offering little more than prophylactic spraying, since it rarely answers the questions of which crop to treat and which fungicide to use. Addressing this perception requires surveillance outputs that resolve not only “if” a pathogen is present, but “which” lineage threatens “which” crop and “what” action is warranted.

The value of biosurveillance increases when detection is linked to traits of direct economic consequence. For example, clade-specific assays for Pseudoperonospora cubensis distinguish genetic groups with different host preferences and fungicide sensitivity profiles. When surveillance results carry this level of resolution, results transition from purely diagnostic to decisional: not only identifying that inoculum is present, but also predicting which crops are at risk and which fungicides are likely to succeed or fail. This enables targeted recommendations, such as treating only cucumber and cantaloupe fields when the cognate clade 2 is present, while sparing non-adapted hosts such as watermelon, pumpkin, and squash, and avoiding chemistries like Carboxylic Acid Amide (CAAs, Fungicide Resistance Action Committee, FRAC 40) fungicides when resistant populations are detected. Such management-relevant biosurveillance moves beyond detection to support precise, cost-effective disease control. Equally important is the question of scale and feasibility. Most spore trapping systems in use today were designed for research and cover only small acreages, making commercial service models prohibitively expensive for growers. For biosurveillance to be adopted on farms, pathogen monitoring technologies can evolve from stationary, labor-intensive devices into scalable, automated platforms. Emerging approaches, including novel trap designs, robotics, and integration with mobile vehicles or drones offer promising routes toward systems that can operate across large production landscapes at a feasible cost. In parallel, integration with cloud computing, real-time data dashboards, and AI-based analytics can shorten the path from detection to recommendation and reduce the gap between data collection and actionable grower recommendations.

Biosurveillance is also expanding beyond molecular assays. Imaging platforms, from unmanned aerial vehicle (UAV)-based hyperspectral sensors to deep learning models for spore identification, are beginning to provide complementary, high-throughput data streams. These methods broaden surveillance from spore capture to symptom detection, offering early-warning signals across spatial scales ranging from individual fields to entire regions. When integrated into decision-support systems, such as the cucurbit downy mildew IPMpipe network, biosurveillance can inform real-time interventions with a high level of spatial and temporal precision. The convergence of molecular and imaging tools creates opportunities for multi-layered systems where inoculum detection, disease forecasting, and crop monitoring work in concert. Despite these advances, key challenges remain, such as variability in trap efficiency, difficulties distinguishing viable from non-viable propagules, and diagnostic inhibitors in environmental samples. Optical and imaging-based approaches also face limitations in resolving pathogens at the species level, particularly among morphologically similar spores, and automated classification systems still struggle to reliably differentiate genera or closely related taxa under field conditions. Equally, operational adoption depends on usability and trust; users can see that surveillance outputs translate into timely, higher-confidence decisions. Overcoming these hurdles is important to translate biosurveillance signals into actionable recommendations.

This review synthesizes recent advances in the biosurveillance of airborne plant pathogens, with emphasis on molecular markers, detection platforms, air sampling technologies, imaging and artificial intelligence (AI) tools, and integration into management. This discussion highlights both scientific progress and the path forward: from detection-centric research systems toward scalable biosurveillance platforms that inform disease management and can be realistically adopted in agriculture. To make early detection actionable, the next step is choosing the right molecular markers, loci that are not only sensitive and specific in air matrices but also tied to management decisions such as crop risk and fungicide choice. Practical considerations, sampling design, data pipelines, and decision thresholds that determine whether promising technologies deliver value at the field scale are also emphasized. By considering biosurveillance through the dual lens of technological innovation and practical feasibility, the present disclosure provides a framework for how this rapidly evolving field can move from proof-of-concept to essential infrastructure in plant disease management.

### 2. Fingerprints in the Air: Markers for Molecular Surveillance

Molecular markers are the foundation of biosurveillance systems, as they determine whether airborne inoculum can be detected with the sensitivity, specificity, and relevance needed to guide management decisions. Unlike diagnostic applications in symptomatic tissue, airborne surveillance can contend with low DNA concentrations, degraded nucleic acids, inhibitors, and a mixture of diverse taxa. Thus, the strategic selection, design, and validation of molecular markers is central to the quality and utility of biosurveillance outcomes. An effective biosurveillance marker can achieve a balance between sensitivity, specificity, and genomic stability (Table 6). Loci such as ribosomal internal transcribed spacer (ITS) or mitochondrial genes are widely used because of their high copy number and sensitivity, which is particularly valuable when inoculum levels are low. However, these markers often lack specificity, and can cross-react with closely related taxa or environmental DNA, leading to false positives. For example, ITS-based assays for Bremia lactucae or Peronospora destructor achieved sensitive detection from spore traps, but their use is constrained by the risk of amplifying non-target oomycetes. Similarly, for tar spot of corn (Phyllachora maydis), a quantitative polymerase chain reaction (qPCR) assay targeting ITS1 enabled sensitive detection of airborne inoculum in spore trap samples and supported predictive modeling of spore presence relative to weather conditions, although specificity remains a concern. Because assays utilizing multicopy targets may sacrifice specificity for sensitivity, many programs complement such assays with species-specific assays to improve reliability in mixed aerobiomes. In practice, marker performance hinges on both the locus and the matrix; air, rainwater, and leaf-wash samples impose different constraints on sensitivity and inhibition.

TABLE 6
Major advantages and disadvantages of molecular markers
used for airborne plant pathogen biosurveillance.

| | | | Disadvantages/ | |
|---|---|---|---|---|
| Source | Loci/Type | Advantages | Examples | Examples |
| Nuclear | Ribosomal | High | Copy | Peronospora destructor, |
| | and Internal | reproducibility | heterogeneity | Peronospora arborescens, |
| | Transcribed | Abundant | Low resolution | Peronospora belbahrii, Plasmopara |
| | Spacer (ITS) | copies | for cryptic | spp., Bremia lactucae, |
| | | Common | species | Pseudoperonospora humuli. |
| | | primers | Species cross- | |
| | | | reactivity | |
| Nuclear | Housekeeping | Common | Low | P. belbahrii, Pseudoperonospora |
| | | primers | polymorphisms | cubensis. |
| | | Known | and | |
| | | genes | reproducibility | |
| | | | Limited for | |
| | | | phylogenetic | |
| | | | analysis | |
| Nuclear | Species- | Species- | Low | P. humuli, P. cubensis, P. belbahrii. |
| | specific | specific | polymorphisms | |
| | | primers | and | |
| | | | reproducibility | |
| | | | Limited for | |
| | | | phylogenetic | |
| | | | analysis | |
| Nuclear | Multilocus | Improves | Low | P. cubensis, P. humuli. |
| | | phylogenetic | reproducibility | |
| | | interpretation | More labor | |
| | | Infraspecific | | |
| | | resolution | | |
| | | High | | |
| | | variability | | |
| Mitochondrial | Single locus | Improves | Uniparental | B. lactucae, P. cubensis. |
| | | phylogenetic | inheritance | |
| | | interpretation | Limited in | |
| | | Infraspecific | detecting | |
| | | resolution | hybrid species | |
| | | High | | |
| | | variability | | |

To increase reliability, many biosurveillance systems rely on species-specific assays. These markers are well suited for pathosystems with low disease thresholds or rapid epidemic onset, where any detection is meaningful. For example, a qPCR assay targeting Peronospora destructor enabled onion downy mildew to be detected in spore trap samples up to 15 days before symptom visualization, providing an actionable early warning of disease. Similarly, species-specific assays have been developed for Peronospora effusa, causal agent of spinach downy mildew, and adapted for spore trap monitoring in production regions of California, where they supported forecasting of epidemic onset. In cucurbits, next-generation sequencing was used to identify P. cubensis-specific markers that distinguish it from the closely related hop pathogen P. humuli, enabling sensitive detection of airborne inoculum in spore traps. Because symptom expression can vary across cucurbit hosts, molecular assays are often required to complement visual diagnosis, particularly outside cucumber. Comparable approaches have been applied to basil downy mildew, where species-specific markers for Peronospora belbahrii have been developed. Species-specific assays have also been developed for Pseudoperonospora humuli, where PCR markers were applied to spore trap and crown samples to monitor inoculum dynamics and overwintering sources. The main limitation of species-level markers is that, by design, they are restricted to a single target species and cannot capture variation across related taxa, limiting their broader applicability. Moreover, species-level detection may miss epidemiologically important variation; lineage- and clade-specific markers address this by linking detection to host range, fungicide response, or other traits of economic concern.

In many pathosystems, disease risk and fungicide efficacy differ among genetic lineages, making clade-specific markers particularly valuable. In cucurbit downy mildew, clade-specific qPCR assays for P. cubensis distinguish isolates that preferentially infect cucumber and cantaloupe (clade 2) from those preferentially infecting watermelon, pumpkin, and squash (clade 1), enabling crop-specific management recommendations. This approach has been extended to spore trap samples, providing real-time data on clade distribution during epidemics. Increasingly, biosurveillance incorporates markers that detect fungicide resistance alleles (Table 7). Examples include the G143A mutation in the cytochrome b gene conferring resistance to Quinone Inside Inhibitor (QoI) fungicides (FRAC 11) and point mutations in CesA3 associated with resistance to Carboxylic Acid Amide (CAA) fungicides (FRAC 40) in P. viticola and P. cubensis. In the corn tar spot fungus Phyllachora maydis, recent genome resources are being leveraged to develop markers that enable lineage tracking and resistance monitoring, expanding biosurveillance capabilities in this emerging disease. These markers allow biosurveillance to guide not just the timing but also the choice of fungicides. Their limitation, however, is scope: a single resistance allele may not capture the full resistance profile of a population, underscoring the need for continuous updating as new mutations emerge. As surveillance questions broaden, multiplex designs that combine identity, lineage, and resistance can extract more management-ready information from each air sample.

TABLE 7
Summary of fungicide resistance mechanisms, validated target-site mutations, and representative species
that can be used for monitoring resistance. FRAC codes indicate fungicide mode of action as defined
by the Fungicide Resistance Action Committee. Amino-acid positions refer to standardized numbering in
the respective target genes (e.g., SdhB, CytB, CesA3). MDR denotes multidrug resistance, often caused
by mrr1 mutations that activate efflux transporters such as AtrB in Botrytis cinerea.

| Active | | Target Site/ | Validated | Representative Species/ |
|---|---|---|---|---|
| Ingredient(s) | FRAC | Mode of Action | Resistance Mutation | Notes |
| Thiophanate- | 1 | β-tubulin | E198A/V/K, F200Y | Botrytis cinerea; allele- |
| methyl | | | | specific assays for |
| | | | | several cereal pathogens. |
| Iprodione | 2 | Class III histidine | I365S/N, Q369P, | B. cinerea. Often coupled |
| | | kinase (Bos1) | N373S | with Mrr1-AtrB efflux |
| | | | | (MDR1/MDR1h) |
| DMIs (e.g. | 3 | CYP51 (sterol 14α- | Y136F/Y137F, S509T, | Alternaria alternata, |
| Difenoconazole, | | demethylase) | I381V, Y461H, S524T, | Alternaria solani, |
| Tebuconazole, | | | D134G, V136A/C, | Blumeria graminis, |
| Flutriafol) | | | K143R; promoter | Erysiphe necator, |
| | | | overexpression and | Zymoseptoria tritici. |
| | | | gene duplication | |
| | | | events also reported | |
| Metalaxyl, | 4 | RNA polymerase I | No single universal | Phytophthora infestans. |
| Mefenoxam | | (rRNA synthesis) | SNP; resistance via | |
| | | | chromosomal | |
| | | | deletions/aneuploidy | |
| SDHIs (e.g. | 7 | Succinate | Botrytis cinerea: | B. cinerea, Alternaria |
| Boscalid, | | dehydrogenase | SdhB P225F/H, | spp. |
| Fluopyram, | | (SdhB/C/D) | N230I, H272R/Y; | |
| Penthiopyrad, | | | Alternaria alternata: | |
| Fluxapyroxad, | | | SdhB H277Y/R/L, | |
| and | | | P230A/R, N235D/T; | |
| Pydiflumetofen) | | | SdhC H134R, S135R; | |
| | | | SdhD D123E, | |
| | | | H133R/P | |
| Cyprodinil | 9 | Amino acid | mrr1 gain-of-function | B. cinerea. MDR-based |
| | | biosynthesis/secretion; | | cross-resistance with |
| | | MDR via mrr1 → AtrB | | FRAC 2 and 12. |
| Qols (e.g. | 11 | Complex III (cytB Qo | G143A, G137R, | Alternaria spp.; portable |
| Azoxystrobin, | | site) | F129L | qPCR/dPCR validated for |
| Pyraclostrobin, | | | | cytB surveillance. |
| Trifloxystrobin) | | | | |
| Fludioxonil | 12 | Osmosensing histidine | I365S/N, Q369P, | B. cinerea: Bos1 |
| | | kinase (Bos1) and | D1158N and AtrB | mutations and Mrr1-AtrB |
| | | stress signaling | efflux | activation yield cross- |
| | | | | resistance with FRAC 2 & |
| | | | | 9. |
| Fenhexamid | 17 | Erg27 (3-keto | F412S/I/V, T63I, | B. cinerea. |
| (hydroxyanilide) | | reductase) | T496R (+other Erg27 | |
| | | | substitutions) | |
| Cyazofamid | 21 | Complex III (cytB Qi | E203-DE-V204 | Plasmopara viticola. |
| (Qil) | | site) | insertion (±L201S) | |
| Ethaboxam, | 22 | β-tubulin | C239S | Phytophthora sojae. |
| Zoxamide | | | | |
| CAAs (e.g. | 40 | Cellulose synthase | G1105S/V/W, | Plasmopara viticola: |
| Dimethomorph, | | (CesA3) | V1109L/M | G1105S predominant; |
| Mandipropamid) | | | | validated TaqMan |
| | | | | available. P. cubensis: |
| | | | | clade-specific G1105W/V |
| | | | | distributions. |
| Fluopicolide | 43 | V-ATPase subunit a | N771S, N846S | Phytophthora capsici. |
| Ametoctradin | 45 | Complex III (Qi- | cytB S34L; AOX | P. viticola. |
| | | proximal) | involvement noted | |
| Oxathiapiprolin | 49 | ORP1 (OSBP-like | G769W | P. capsici. |
| | | protein) | | |

To maximize information from scarce airborne samples, multiplex assays that combine species identity, lineage assignment, and resistance markers in a single reaction are an emerging frontier. While technically challenging, these approaches provide the most management-relevant data per sample. Recent advances in genomics and pangenomes have expanded the pool of candidate loci, making multiplex marker design more feasible. Regardless of marker type, validation under field conditions should be completed. Assays can be tested on DNA extracted from spore trap rods, leaf washes, or soil, where inhibitors and low target abundance are common hindrances. Studies in cucurbits, grape, and hop have shown that both qPCR and isothermal assays (e.g., loop-mediated isothermal amplification [LAMP]) can perform robustly outside the laboratory if extraction protocols are optimized. Together, these examples illustrate how marker choice should be dictated by the surveillance question, whether warning of inoculum presence, host risk, or guiding fungicide selection.

Looking forward, the field can prioritize “fit-for-purpose” markers that detect not only pathogen presence but also traits that influence management. This requires close integration between molecular biology, epidemiology, and extension to ensure that marker outputs, whether crop risk or fungicide resistance, translate into timely, actionable recommendations for growers. Beyond individual pathosystems, marker-based surveillance is also being integrated into national sentinel plot networks that monitor pathogens across millions of acres, including soybean rust (Phakopsora pachyrhizi), wheat stripe rust (Puccinia striiformis f. sp. tritici), and southern corn rust (Puccinia polysora). Molecular assays applied in these networks validate field observations and feed into national maps updated during the season, illustrating how marker development can scale from individual fields to regional early warning frameworks.

### 3. Casting a Wider Net: Metagenomic Windows into Airborne Pathogens

Although targeted markers remain the workhorses of operational biosurveillance, high-throughput sequencing now enables “meta-surveillance,” characterizing entire airborne communities and their functional genes when targets are unknown or evolving. Meta-biosurveillance is a relatively new interdisciplinary field that integrates high-throughput multi-omics, computational tools, and other data sources to detect and monitor known and novel pathogens. Using molecular bioinformatics, it applies -omics tools such as metagenomics to characterize the taxonomic and functional composition of microbial communities (microbiomes) in general and those collected from the air (aerobiomes). Amplicon-based sequencing (metabarcoding) targets short DNA fragments (<150-300 bp) to reveal microbial diversity and relative abundance. Single genetic markers (ITS for fungi, 16S for bacteria), enable taxonomic identification as they are conserved across phyla, yet variable enough to delineate many genera. For example, amplicon-based sequencing of rice field aerobiomes were screened for common fungal pathogens, including Alternaria spp., Cladosporium spp., and Magnaporthe oryzae and were found at varying abundances across the growing season. With increasingly accessible sequencing pipelines, researchers can identify thousands of culturable and unculturable microorganisms in a single run, making amplicon sequencing a rapid method for detecting potential aerial plant pathogens and extending these insights to biosecurity-relevant taxa. Recent field work in Alberta, Canada, demonstrated that air metabarcoding can detect a broad spectrum of crop pathogens but that read counts correlate only weakly with qPCR-based spore quantification. Moreover, different sampler types (rotating arm versus Burkard) yielded distinct community profiles, underscoring the need to match sampler design to monitoring objectives and to interpret relative abundance cautiously.

Shotgun metagenomics, by contrast, sequences entire genomes from air samples, generating terabytes of data with high statistical confidence and taxonomic resolution. Unlike amplicon methods, it is primer-agnostic and avoids issues such as primer mismatch and multi-copy biases. Shotgun sequencing has been used to identify Calonectria pseudonaviculata, the causal agent of the recent boxwood blight epidemic, and has the potential to distinguish among Magnaporthe oryzae pathotypes infecting rice (Oryza), wheat (Triticum), millet (Panicum), oat (Avena), and others. Whole-genome data provides additional levels for surveillance, including functional gene profiles such as effector genes and fungicide resistance markers. This capacity to capture both identity and function makes shotgun metagenomics a powerful tool for emerging disease surveillance.

When meteorological and biological data are integrated for meta-biosurveillance, where, when, and how airborne fungal and bacterial communities disperse can be learned. Aero biome data and phenotypic traits of fungal spores (height, width, perimeter, major and minor axis, Feret's diameter, skew, and circularity) were collected from volumetric and rainwater spore trap samples across forests and shrublands. Forests yielded smaller, rounder spores, whereas shrublands, subject to greater wind exposure and higher UV light, produced larger, elongated spores with thicker cell walls. These morphologies enhance survival in harsher conditions, and elongated, streamlined spores facilitate long-distance dispersal. Such analyses reveal how spores disperse across natural vegetation and could inform models of pathogen spread in cropping systems. When the metagenomes of bacteria, fungi, and plants were collected from tropical atmospheric systems, the aero biome exhibited a consistent daily cycle. Long-term environmental monitoring over a year revealed a stable core of microbial taxa, highlighting the durability of these communities. Unlike soils or aquatic habitats dominated by prokaryotes, the airborne biomass in tropical regions was primarily composed of eukaryotic DNA. Certain fungal and bacterial species showed strong associations with temperature, humidity, and CO₂ levels, suggesting their potential as biomarkers for tracking bioaerosol dynamics. These findings illustrate how meta-biosurveillance can capture ecological dynamics beyond presence/absence of pathogens.

Despite their power, metagenomic approaches to detect the presence of pathogens are not without limitations. Protocols for sample collection and data processing vary widely, reducing comparability across studies. DNA-based approaches cannot confirm the viability of captured DNA and, once detected, additional surveillance methods, such as microbial culturing may be needed. Reference databases such as UNITE and GreenGenes aid species identification but remain incomplete, particularly for novel or non-imported pathogens. Even so, high-throughput sequencing remains a robust, rapid approach for pathogen detection in environmental samples. Another challenge is ensuring standardization, as protocols for sample collection and data processing vary widely, reducing comparability across studies.

Beyond the detection of fungi and functional genes, meta-biosurveillance systems can be used to detect or describe within population variation at various levels of resolution using multi-site or multi-gene markers. In Botrytis cinerea, a diverse species complex with a broad host range, such approaches have enabled differentiation of closely related taxa (e.g., B. pseudocinerea), detection of multiple fungicide resistance alleles, and novel variation associated with multiple fungicide resistance. For obligate pathogens with fewer genomic resources, such as Pseudoperonospora spp, or Erysiphe spp., these approaches remain more challenging, as shown in grape aerobiomes where the presence of Erysiphe spp. was detected but species differentiation was not possible without additional markers and testing. Thus, the value and ease of implementing metagenomics depends on the resolution needed: community-level monitoring versus species- or lineage-specific calls.

Meta-biosurveillance is a powerful approach, yet there is still a need for community-standardized protocols for sample collection and data processing to ensure reproducibility and meta-study comparisons. Sampling bias, arising from differences in trap type, placement, duration, or environmental conditions, can distort estimates of pathogen abundance and community composition, limiting comparability across sites and studies. Designing sample collection and processing strategies around pathogen biology and specific research questions is important. Despite these limitations, metagenomics is rapidly expanding the scope of biosurveillance, especially when integrated with traditional targeted assays, and has the potential to link microbiome dynamics with agricultural disease forecasting and management.

### 4. Weapons of Choice: Detection Platforms for Molecular Surveillance

Proactive biosurveillance depends on detecting low, pre-symptomatic levels of pathogens across matrices (e.g., air and rainwater) where many non-target organisms may also be present. Microscopy and pathogen isolation are valuable but tedious, require expertise, and often not possible in air samples due to low pathogen titer. Molecular platforms, including qPCR, LAMP, recombinase polymerase amplification (RPA), digital PCR (dPCR) including digital droplet PCR (ddPCR), and CRISPR-based assays, have been widely applied to oomycetes such as downy mildews and illustrate both the opportunities and challenges of these approaches. These methods complement one another across sensitivity, turnaround time, quantification, portability, and cost (Table 8). They support both detection markers (species/lineage) and management markers (e.g., fungicide resistance related single nucleotide polymorphisms [SNPs]), and integrate with air sampling systems, decision-support tools, epidemiological models, and broader metagenomic surveillance frameworks. For example, molecular tools can be used to quantify and track pathogen spore concentration, and these results can inform fungicide timing.

TABLE 8
Comparison of detection platforms used for airborne pathogen biosurveillance.

| | Time | | | | | | | Best-fit | |
|---|---|---|---|---|---|---|---|---|---|
| | to | Temp/ | | | | Inhibitor | Field- | Use | Key |
| Platform | Result | Instrument | Sensitivity | Quantification | Multiplex | Tolerance | Ready? | Cases | Limitations |
| qPCR | 45-120 | Thermocycler | High | Quantitative | Good | Moderate; | Limited | Routine | Clean |
| | min incl. | (lab/portable) | | via | (2-5+) | needs | (portable | surveillance; | extraction |
| | extraction | | | standard | | quality | units | thresholds; | & power |
| | | | | curve | | extracts | exist) | resistance | required; |
| | | | | | | | | markers | lab-leaning |
| LAMP | 15-45 | Isothermal ~60- | Moderate- | Semi- | Low | Good; | High | On-farm | Primer |
| | min | 65° C.; | high | quantitative | | tolerates | | triage; rapid | complexity; |
| | | simple | (assay- | (probe/ | | crude | | yes/no; | contamination |
| | | heater | dependent) | dye devices) | | extracts | | vector/host | risk; |
| | | | | | | | | screens | limited |
| | | | | | | | | | multiplex |
| RPA | 10-30 | Isothermal ~37- | Moderate- | Semi- | Low- | High | Very high | Rapid field | Reagent |
| | min | 42° C.; | high | quantitative | moderate | | | calls; crude | cost; |
| | | handheld | | (fluorometric) | | | | matrices; | primer/probe |
| | | readers or | | | | | | lateral-flow | idiosyncrasies; |
| | | LFD | | | | | | readouts | modest |
| | | | | | | | | | multiplex |
| ddPCR/ | 90-180+ | Droplet | Very | Absolute | Moderate | Good; | Not | Reference | Capital |
| dPCR | min | generator + | high | (no std | (2-3) | (partitioning | portable | testing; | cost; |
| | | reader | (low- | curve) | | dampens | | calibration; | throughput; |
| | | (ddPCR), | copy | | | inhibition) | | rare allele | lab- |
| | | dPCR | targets) | | | | | detection | bound |
| | | machine | | | | | | | |
| CRISPR- | 20-60 | Isothermal/ | High; | Semi- | N/A | Moderate | High | Rapid, | Supply |
| based | min | RT + | SNP- | quantitative | | (depends on | (strip/ | specific | chain |
| | (often | CRISPR | level | (evolving) | | extract | portable | species/ | maturity; |
| | with | readout | specificity | | | & pre- | readers) | strain/ | standardization; |
| | pre- | | | | | amp) | | SNP calls | contamination |
| | amp) | | | | | | | | if pre- |
| | | | | | | | | | amp |

qPCR remains the lab standard for detecting airborne inoculum because of the high sensitivity/specificity and quantitative outputs amenable to quantitative analyses and modeling. In vineyards, qPCR-based estimates of airborne E. necator inoculum abundant have been used to extend spray intervals without compromising control, illustrating how molecular tests can translate to management. In the same system, qPCR assays have also detected FRAC 11 resistance alleles in airborne samples, linking surveillance directly to fungicide stewardship. Early P. viticola work established robust qPCR quantification from leaf and environmental samples, and more recent assays resolve clade differences in airborne inoculum, which is important when pathogenicity, virulence or sensitivity profiles diverge between clades. Limitations include instrument needs, trained personnel, and inhibitor-resistant extraction methods. Portable thermocyclers narrow the lab-field gap, but per-test costs and extraction quality still govern feasibility.

Loop mediated isothermal amplification (LAMP) runs at a constant ˜60-65° C. with rapid time-to-answer (often ≤30 min) and simple readouts (colorimetric, turbidity, or fluorescent), enabling field-friendly detection from crude extracts. LAMP operates at a constant temperature using a strand displacement polymerase. LAMP is the most widely published non-PCR based method in plant pathology, expanding access to on-site diagnostics for surveillance and management. Unlike other isothermal assays, LAMP is also capable of accurately discriminating SNPs which is a big advantage in detecting fungicide resistance. Practical constraints include cost, complex primer sets (6-8 priming regions), limited multiplexing, contamination risk from large concatemers, and variable performance when inhibitors are high. For these reasons, careful assay design and workflow controls are essential. Despite these caveats, LAMP's simplicity has made it a cornerstone for rapid, field-deployable assays.

Recombinase polymerase amplification (RPA) amplifies nucleic acid at 37-42° C. in 10-25 min and tolerates many inhibitors, which suits air/soil/water and crude plant extracts. Readouts include lateral-flow strips for binary calls and fluorometric devices for semi-quantitation. RPA assays are particularly attractive for decentralized, resource-limited settings or when ambient-temperature operation is required. Constraints include higher reagent cost, idiosyncratic primer/probe rules (affecting transferability), and limited multiplexing relative to qPCR. To date, RPA has rarely been applied to airborne samples in plant pathology, leaving its potential for biosurveillance largely untapped. Future work should explore its deployment in aero biome contexts, where inhibitor tolerance and rapid result delivery may offer an advantage.

Digital droplet, and its successor, digital PCR (ddPCR/dPCR) partitions reactions into thousands of droplets, delivering absolute quantification without standard curves and increased resilience to moderate inhibitors. It is well-suited to (i) calibrating surveillance thresholds, (ii) confirming very low-titer targets in environmental samples, and (iii) quantifying rare alleles (e.g., fungicide-resistance mutations) that inform management. In grape downy mildew, multiplexed real-time and digital PCR have been used to differentiate P. viticola clades, illustrating how dPCR can better differentiate subpopulations of closely related taxa. Trade-offs include capital cost, lower throughput vs. high-capacity qPCR, and lab-bound workflows. Still, dPCR provides a level of confidence at low copy numbers that can be important in early-warning systems.

CRISPR-based diagnostics pair a target-recognizing guide with collateral nuclease activity to produce simple fluorescent or lateral-flow signals, often after a short isothermal pre-amplification or a PCR based amplification. They offer SNP-level specificity in portable formats and have advanced quickly for plant viruses and vector-borne pathogens; extensions to fungi, oomycetes, and even nematodes are emerging. The most widely used enzymes are Cas12a and Cas13a, which upon activation, cleave nonspecific single-stranded DNA or RNA reporters, respectively, enabling versatile detection across pathogen groups. Proof-of-concept and field-leaning studies show sensitive detection of Tomato brown rugose fruit virus (ToBRFV) and pine wood nematode with minimal hardware, highlighting a pathway to strain-aware management markers at the point of need. Current bottlenecks include significant cost, speed of the assay, limited point-of-need reagent availability, guide design, and standardization of quantitative interpretation. Even so, CRISPR-based platforms represent one of the fastest-moving frontiers for portable and precise diagnostics.

Effective molecular detection in air samples need to align platform choice with question, matrix, and logistics: qPCR for routine, quantitative surveillance and resistance genotyping in centralized labs; LAMP or RPA for rapid, on-farm yes/no or semi-quantitative decisions; dPCR/ddPCR for calibration and rare-allele confirmation; and CRISPR as a fast-emerging option for SNP-resolved field calls, with potential to combine portability, specificity, and management relevance. The growing options of platforms underscores that no single tool fits all contexts; instead, matching technology to the biology of the pathogen and the decision-making needs of growers is essential.

### 5. The Hardware of Air Sampling: Spore Traps and Beyond

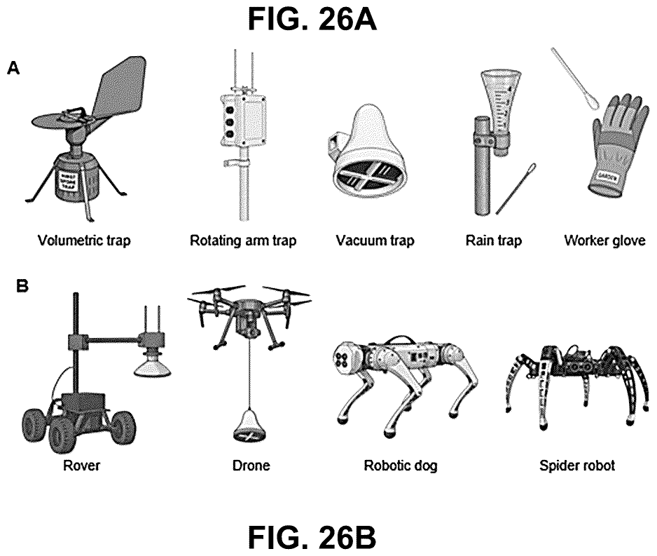

Active spore traps have become common tools used for plant disease surveillance with increased interest in technology development in recent decades (FIG. 26A). Among the earliest active spore traps, rotating arm samplers were introduced in 1957 by W. A. Perkins, originally for pollen monitoring, and soon adapted for plant pathogen collection. rotating arm impaction samplers have undergone many iterations and remain widely used due to their affordability and adaptability compared to commercially available devices such as volumetric samplers (Burkard Manufacturing Co. Ltd.). Studies using Burkard volumetric spore traps have demonstrated clear epidemiological links between spore concentrations, environmental factors, and epidemic development. For example, Granke et al. showed that concentrations of airborne P. cubensis sporangia detected with volumetric traps correlated with temperature, leaf wetness, and subsequent downy mildew severity in Michigan cucumber fields, highlighting how trap data can directly inform disease risk. While the core design is conserved, factors such as height, mounting equipment, power sources, programming devices, and housing can be modified to fit a researcher's needs. These changes, however, can alter sampling efficiency and the volume of air processed, influencing detection rates.

Rotating arm samplers support downstream molecular analyses including PCR and qPCR. They have also been paired with sequencing technologies to investigate aerobiomes and novel pathogen detection. Protocols for building and deploying rotating arm samplers have recently been published, improving accessibility. Despite this, few coordinated sampling networks exist due to logistical and funding challenges. Networks are particularly valuable for high-value crops such as grapes, where low disease thresholds and intensive fungicide use make early warning important. Thus, rotating arm devices remain central to biosurveillance, but their reach is limited by the absence of scalable, well-supported networks.

The future of rotating arm sampling remains uncertain as newer technologies improve capture efficiency and require less maintenance, but often at higher cost. The affordability and simplicity of rotating arm samplers keep them valuable in research settings and for proof-of-concept biosurveillance. For integration into management programs, more research is needed on placement, deployment timing, and integration with decision-support systems. As molecular tools become cheaper, rotating arm samplers will likely continue to broaden in application, especially if updated with design improvements such as 3D-printed parts, Bluetooth or wireless connections, and compatibility with in-field diagnostics.

Engineering advances have produced vacuum-based traps with greater sampling efficiency, due to their suction capability, and adaptability, especially when integrated with robotic platforms (FIG. 26A). A customized vacuum trap designed by Xiang and Quesada employs a brushless fan that draws air past adhesive-coated rods. Captured inoculum can then be analyzed. The trap is controlled via an Arduino system with a ducted fan, Bluetooth module, and 3D-printed hood, enabling real-time optimization of fan speed. Relative to existing devices, the vacuum trap has greater suction capacity, increasing collection efficiency. Integration with mobile platforms has been central to this work. Field-based deployment has tested unmanned aerial vehicles (UAVs), unmanned ground vehicles (UGVs), and legged robots (FIG. 26B). UAVs are attractive for portability and throughput but limited for canopy-level sampling. UGVs perform well in row crops on flat terrain but struggle in sprawling vegetation. To overcome these limitations, a six-legged bionic hexapod robot was developed, equipped with inertial sensors, real-time balance control, and adaptive gait for navigating vines and uneven terrain. Field trials confirmed stability across slopes and obstacles, underscoring the feasibility of robotic biosurveillance. Beyond design, a key question is performance: how do these mobile systems compare with stationary traps under field conditions?

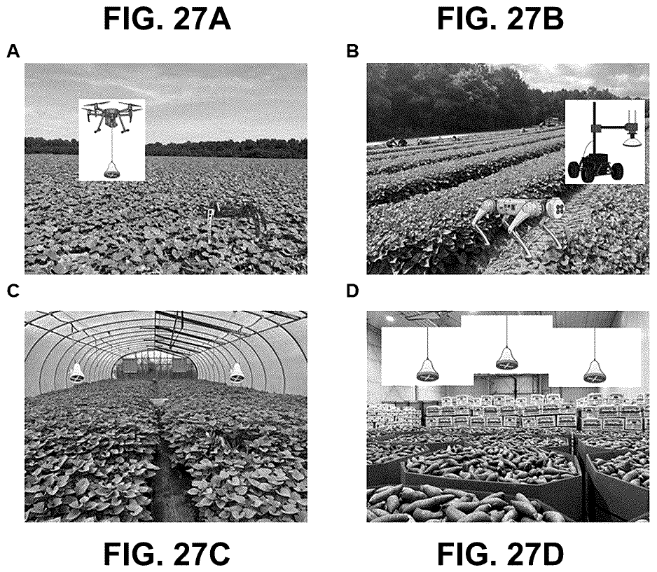

Spore trap research spans three elements: sampling, sample processing, and detection. While molecular detection has advanced rapidly, the basic principles of spore trapping remain similar. Stationary devices such as Burkard volumetric traps and rotating arm samplers have long been used in diverse crops, but their immobility constrains coverage in large-acreage systems. These tools have also proven valuable across other systems, including ornamentals, where environmental variables such as temperature and leaf wetness were shown to influence airborne concentrations of Peronospora antirrhini in snapdragon, demonstrating how spore detection can inform disease forecasting beyond major field crops. Recent research has demonstrated that mobile spore trapping is feasible and increases detection power for the cucurbit downy mildew pathogen. In field trials, mobile vacuum traps outperformed paired stationary rotating arm samplers: rover-mounted vacuum traps achieved a 0.50 probability of detecting P. cubensis vs. 0.39 for rotating arm, and UAV-mounted vacuum traps achieved 0.63 vs. 0.51 for rotating arm samplers. These results suggest that mobility enhances interception of airborne inoculum, especially in sprawling canopies and large fields (FIGS. 27A-D).

In summary, there are a continuum of spore trapping technologies, from low-cost rotating arm designs to advanced robotic vacuum systems, that can be aligned with pathogen biology, crop architecture, and management needs. The challenge moving forward is about integration, choosing the right device for the right crop system and embedding its outputs into decision-making frameworks (FIGS. 27A-D).

### 6. Eyes in the Sky: Biosurveillance Through Imaging

As noted previously, management interventions should be timely for plant protection to be effective. The management process can be framed in two key intervals: the time from disease onset to detection, and the time from detection to intervention. Shortening either interval increases the chance of successful disease management. Optical sensing offers a powerful way to move beyond historical limitations of human visual scouting to achieve this timeliness. Imaging tools transform disease detection from a passive data collection exercise into an active component of this management interval.

An imaging-based biosurveillance framework can support both preventative and responsive strategies. Preventative approaches (e.g., host resistance, prophylactic fungicides, cultural control) alter one or more elements of host, pathogen, or environment to delay their convergence and disease onset (ideally indefinitely). In contrast, responsive strategies focus on acting as quickly as possible once after an outbreak begins. Time-resolved optical imaging can shrink the onset-to-detection window and support targeted deployment to compress the detection-to-intervention window.

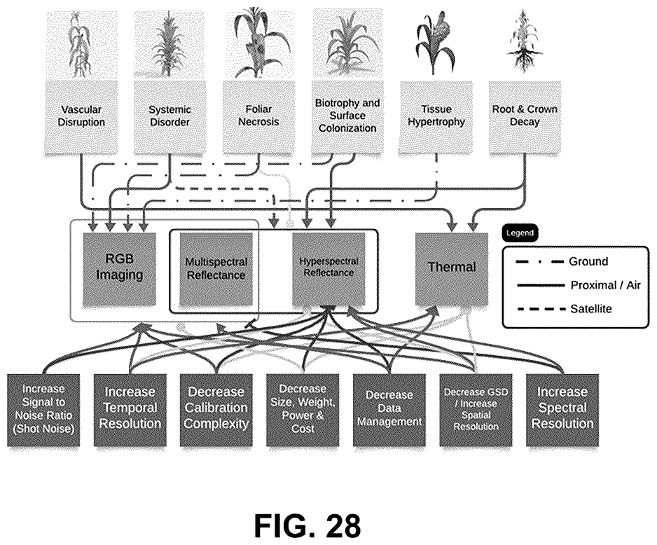

To use imaging effectively, detection strategies should be grounded in pathosystem biology. For surveillance and management, it is important to consider the physiological “taxonomy” of pathosystems (FIG. 28). This categorizes host-pathogen interactions by their physiological manifestations rather than their taxonomic group (e.g., bacteria, virus, fungus). Each class produces distinct, sensor-detectable signatures. For example, vascular disruptions such as those caused by Fusarium wilt lead to pre-visual water stress that can be detected through thermal imaging and canopy temperature monitoring. Systemic colonization by viruses or bacteria alters plant chemistry and physiology throughout the canopy, making these pathosystems particularly suitable for airborne and satellite-based multi- or hyperspectral sensing. In contrast, localized necrosis caused by foliar pathogens often begins deep within the canopy, requiring high spatial resolution from proximal platforms such as UAVs or ground rovers for early detection, since airborne and satellite sensors lack the resolution to capture small lesions.

Understanding these physiological signatures provides a framework for selecting the most appropriate sensor and deployment platform for each pathosystem. For pathogens with long latent periods, pre-visual detection using high-resolution imaging spectroscopy is a priority. In contrast, for fast-moving, polycyclic diseases such as rusts, rapid change detection with high-temporal-resolution sensors is more informative. Management thresholds further refine these priorities: for zero-tolerance quarantine pathogens (e.g., wheat blast), minimizing the onset-to-detection interval is paramount, whereas for foliar diseases with defined economic thresholds, the greater value may come from reducing uncertainty in the detection-to-intervention interval, enabling more precise and confident management actions.

Imaging spectroscopy is uniquely suited for this work because its near-continuous spectral data can quantify changes in plant physiology, biochemistry, and structure. Disease fundamentally alters how plants interact with solar radiation, and these spectral perturbations are the signals that are exploited. Spectroscopy provides the biochemical sensitivity needed for pre-visual detection, while deploying spectroscopy on multi-scale platforms gives the spatial and temporal resolution to act within the management timeline.

Ultimately, for biosurveillance to be adopted, it should be actionable. An effective system can deliver information that connects to decisions. This means pairing an optimized sensing pipeline with epidemiological modeling and decision support systems to enable a clear understanding of the available intervention options and the practical barriers to implementation. By starting and ending with the pathosystem's biology and focusing on the specific intervals that limit management, truly deployable tools can be developed that reduce uncertainty at the right moments in the season.

Selecting the right tool, as guided by the pathosystem taxonomy in FIG. 28, is not just a biological decision but an engineering one that involves balancing multiple, often competing, design tradeoffs. These tradeoffs include the need to increase signal-to-noise ratio (SNR), improve temporal resolution, and enhance spectral and spatial resolution (i.e., decrease ground sample distance, or GSD), while simultaneously reducing calibration complexity, data management demands, and overall size, weight, power, and cost (SWaP-C). For example, hyperspectral reflectance sensors offer the high spectral resolution needed for pre-visual detection of chemical changes from systemic or biotrophic pathogens, but this comes at the cost of significant data management complexity and historically high SWAP-C. Conversely, RGB or optimal multispectral sensors provide excellent spatial resolution and low SWAP-C, making them ideal for tracking visible necrosis or canopy structure, but their limited spectral information restricts early detection capabilities. Thermal imaging, which is well-suited for detecting vascular disruptions caused by water stress, often requires additional calibration to account for environmental variables and may have a larger GSD than RGB systems.

Once a sensor is chosen based on these trade-offs, its data should be translated into actionable intelligence through predictive models. These models process specific sensor inputs, such as full spectral curves, reflectance indices, or canopy temperature deviations, and convert them into disease-relevant indicators or management decisions. For example, models can combine UAV-derived thermal and multispectral data to generate field maps that predict infection risk or guide variable-rate fungicide applications. The most effective models are those whose data requirements align with practical, scalable sensing strategies and whose outputs directly integrate into existing decision-support systems for disease management.

To realize the full potential of remote sensing, the agricultural community should move beyond model development toward creating a unified digital ecosystem for their management and deployment. Currently, novel algorithms are presented across many research papers and code repositories, creating a translational gap between their publication and practical application. While user-friendly platforms are emerging, a broader, integrated system is still needed. Integration can involve a coordinated effort, building upon foundational cyberinfrastructure projects and community-wide initiatives, to create platforms that can save, categorize, and deploy diverse, validated models with standardized protocols. Such infrastructure would enable biosurveillance networks to seamlessly integrate imaging, molecular, and environmental data streams, linking field sensors and air samplers to predictive models and decision-support systems. This integration would deliver real-time, interpretable risk maps and management recommendations directly to growers and crop consultants.

Beyond deployment, establishing trust in these sensor-driven models is an added barrier. Trust is often decreased when models are trained and tested on limited datasets, such as data from only a few seasons at one location, without robust validation on completely independent seasons or across new environments. Furthermore, even a well-validated model should handle confounding factors in production fields, where signals from disease can be easily mistaken for signatures of nutrient deficiency, water stress, or complex Genotype×Environment×Management interactions. The path forward can focus on creating not just predictive models, but interpretable ones, coupled with rigorous validation protocols and an infrastructure that transforms promising research into reliable and accessible tools for crop improvement and protection.

### 7. Closing the Circle: Turning Biosurveillance into Grower Decisions

Surveillance of airborne inoculum has progressively shifted from proof-of-principle experiments and research-based applications to components of risk assessment in commercial applications. This trajectory mirrors the development of other disease predictive systems that began as research tools supported by public-sector funding and later transitioned into commercial products adopted regionally and on individual farms (40). Quantification of airborne inoculum by PCR or other DNA amplification methods has largely replaced manual enumeration of trapped fungal spores. One of the most common applications of airborne inoculum surveillance remains the initial detection of the inoculum source, often a discrete event that often has immense importance for efficient disease intervention. Examples exist across diverse pathosystems, especially for diseases where the timing of the first fungicide application is important or where inoculum is dispersed over long distances. Such systems are particularly valuable for high-value fruit and vegetable crops, where superior disease control justifies investment. In lower-value field crops, adoption is often motivated more by savings from avoiding unnecessary sprays than by improved disease control.

Empirical thresholds for inoculum density are routinely used to initiate or adjust fungicide applications. Markers and biosurveillance systems that predict traits of economic consequence such as host preference or host range, pathogenic race, and fungicide resistance are increasingly being developed as the underlying genetic determinants are identified. A defining case of this translational progression is cucurbit downy mildew, where marker-based assays have evolved from species detection to clade- and resistance-informed management tools. By linking inoculum detection to host preference and fungicide efficacy, this system exemplifies how biosurveillance can move from passive diagnostics toward targeted, resistance-aware disease control. Efforts are now underway to integrate these tools into regional networks such as the cucurbit downy mildew IPMpipe.

Parallel efforts are emerging in field crops. Here, biosurvellience can be for direct detection of a disease hazard or for biological data acquisition to build predictive models connecting inoculum pressure, weather, and disease outcomes. As genomic resources are now routinely available for economically important pathogens, this opens the door to monitoring alleles for resistance to fungicides with well characterized resistance mechanisms. These developments lay the groundwork in broad-acre crops for the same kind of integrated detection-resistance systems that have been piloted in higher value crops.

Complementary progress has also been made in proximal and remote sensing biosurveillance, which extends early detection beyond trapped inoculum to the host canopy itself. In grapevine, for instance, hyperspectral and thermal imaging have enabled early identification of downy mildew and viral infections, guiding spatially targeted sprays and cultivar selection. Similarly, UAV- and ground-based imaging in cucurbits and solanaceous crops has been used to map disease spread and support within-field management decisions. As these imaging systems are increasingly coupled with molecular diagnostics and decision-support tools, they represent a complementary pathway toward fully integrated, multi-sensor biosurveillance.

While most biosurveillance efforts have focused on open-field applications, parallel work extends these approaches to other production contexts such as greenhouses. In intensive production systems the crops tend to be of higher value and the information on inoculum abundance and phenotype can therefore be highly valuable. There is also growing recognition of the role of biosurveillance in postharvest disease management. Storage pathogens can spread rapidly under confined conditions, and monitoring tools, including molecular diagnostics and spore detection, offer the potential for early warning and mitigation to protect crop quality and marketability. Together, these examples show that biosurveillance is relevant not only in the field but across the entire production and supply chain (FIGS. 27A-D).

Despite this progress, current biosurveillance infrastructure remains heavily reliant on public funding and is often limited to a few key pathogens. Most crop-specific surveillance programs are built around a small number of sites, and true real-time, field-level applications remain rare. However, commercial applications are expanding. Several companies now offer inoculum detection from spore traps or field-collected samples such as workers' gloves, with services bundled into broader crop protection or consulting packages. The value of biosurveillance increases as networks of samplers are scaled up and integrated across regions, and as sampling becomes more frequent and results are delivered in real time. Advances in automated, in situ detection platforms, including biosensors, CRISPR-based diagnostics, wireless data integration, and computation resources are beginning to support these real-time systems.

Yet foundational questions remain. Where should devices be placed to best represent inoculum risk within a field or landscape? What is the optimal density of samplers per hectare or per crop system? Precise answers to these questions depend on complex interactions between pathogen biology, microclimate, landscape structure, and crop phenology that are just now being addressed. Similar questions of scale and resolution extend to other biosurveillance domains: what sequencing depth captures meaningful shifts in the aero biome, and what spatial or spectral resolution is needed for imaging systems to detect disease before visible symptoms appear? Ultimately, sustained use will depend on perceived value relative to current practices. Adoption is influenced by grower experience, regulatory pressures, and the rising prevalence of fungicide resistance. For biosurveillance to become routine, it should deliver not just data, but data that users trust, can interpret easily, and act upon with confidence.

### Example D

### 1. Introduction

Cucurbit downy mildew (CDM), caused by Pseudoperonospora cubensis, is a major constraint to cucurbit production in the United States. The pathogen comprises two genetic clades that differ in host preference and fungicide sensitivity, and management relies heavily on weekly applications of site-specific fungicides in the absence of complete host resistance. Effective, cost-efficient control requires early detection of airborne inoculum and in-season information on clade prevalence and fungicide resistance. Here, a field-deployable CDM biosurveillance system is evaluated that integrates mobile vacuum-based spore trapping with qPCR assays for clade identification and fungicide resistance monitoring. Across two years of research plots and a commercial cucumber field, mobile traps, particularly a UAV-mounted vacuum trap, detected P. cubensis more frequently and earlier than stationary rotating arm samplers, including several weeks prior to visual symptom development. These results demonstrate that mobile spore trapping enables rapid, scalable sampling and supports early, clade-specific detection of CDM. This biosurveillance framework provides growers with actionable, real-time inoculum data that can guide fungicide programs and help mitigate fungicide resistance.

Plant pathologists have been sampling air to track pathogens for decades, but the practice has entered a new era. With molecular tools transforming traditional spore trapping into a high-resolution biosurveillance system, spore monitoring now has direct, actionable impacts on disease management. Spore traps not only reveal patterns of inoculum movement and dispersal, but their results feed into disease forecasts and decision support systems. The scale of deployment has also expanded, from local experiments to national monitoring networks such as those for Fusarium head blight in Belgium, and soybean rust across North America. More recently, broad-spectrum spore surveys are uncovering patterns of airborne pathogen diversity at unprecedented scales, underscoring the growing importance of spore trapping as a cornerstone of modern plant disease epidemiology.

Despite rapid progress in molecular diagnostics, the core science of spore trapping, and even the design of the samplers themselves, has remained remarkably similar for decades. Rotating arm samplers, for instance, are still among the most common in use today. Opportunities for innovation exist across every stage of spore trap research, from sampling and detection to processing and data analysis. The field is now advancing toward real-time spore detection integrated within networks that provide actionable information to growers, directly enhancing disease management. With continued advances, spore trapping could redefine how to anticipate and respond to plant disease outbreaks, ushering in a new era of intelligent, data-driven crop protection.

Spore trapping has been employed specifically to monitor cucurbit downy mildew (CDM). Pseudoperonospora cubensis is an obligate oomycete that causes CDM, a major disease of cucurbits including cucumber, squash, watermelon, pumpkin, and cantaloupe. In the U.S., CDM was largely managed through host resistance in cucumber until a severe epidemic in 2004 led to unprecedented yield losses. Since then, annual outbreaks have made CDM the primary threat to cucurbit production. P. cubensis includes two genetic clades that differ in host preference and fungicide sensitivity: Clade 1 infects watermelon, squash, and pumpkin, while Clade 2 targets cucumber and cantaloupe. Effective spore trapping can utilize not only traps but also molecular markers with high specificity. For CDM, qPCR assays now enable clade-specific detection, and spores have been detected in research fields before symptom appearance. This capacity can inform fungicide programs by signaling when to begin sprays, rather than relying on routine weekly applications. However, stationary traps remain limited in large-scale production because they are impractical for growers to use across broad acreages.

CDM is an airborne disease managed primarily with weekly applications of downy mildew-specific fungicides, which are costlier than standard products. The CDM ipmPIPE forecasting system was developed to reduce sprays, but its reliance on visual confirmation limits its usefulness because symptoms are difficult to identify at early stages, when fungicides are most effective. Fungicide resistance further complicates management, yet growers lack in-season monitoring tools. Molecular markers have been identified for resistance to Carboxylic Acid Amides (CAA) and Quinone Outside Inhibitors (QoI), as well as for Oxathiapiprolin (OXTP), resistance has been shown to vary by clade. While CAAs and QoIs are not relied on heavily for CDM management, OXTP has become a key chemistry for growers. Integrating OXTP markers with spore trapping could provide real-time information on pathogen presence and fungicide sensitivity, offering growers a more effective strategy for resistance management.

The availability of clade-specific and fungicide resistance qPCR assays for OXTP and other chemistries creates a unique opportunity to build a cucurbit downy mildew (CDM) biosurveillance system capable of delivering early pathogen detection, crop risk assessment, and fungicide sensitivity information, all before symptoms appear in the field. Realizing this potential requires designing a spore trapping system that can scale to large acreages while maintaining the sensitivity needed for pre-symptomatic detection. To address this challenge, embodiments of the present disclosure aimed to: (i) evaluate alternative spore trap and vehicle combinations against the traditional rotating arm ground trap used by Rahman et al. (2021) for P. cubensis early detection in research fields, (ii) test if qPCR fungicide resistance assays can be incorporated into a biosurveillance system of the present disclosure, and (iii) explore whether select spore trap-vehicle combinations can enable successful detection of P. cubensis across production-scale fields.

### 2. Materials and Methods

Sampling locations. Field trials were conducted at two sites: (i) the Central Crops Research Station, Clayton, NC, in 2023 and 2024, and (ii) a commercial cucumber field in Duplin County, NC, in 2024. Research plots included 8 rows (100 ft each), alternating cucumber (‘Liszt’) and squash (‘Butternut Waltham’), planted on May 9, 2023, and May 16, 2024. Seeds were planted 1 ft apart and the spacing between the rows was approximately 5 ft. In both years, at the research station, a replant or extra planting of rows occurred to ensure continuous plant and disease pressure availability through the field season. In 2023, half of the rows were replanted on August 8. Sampling kept going on the original rows and on August 29, all sampling started occurring on the newly replanted rows. In 2024, an additional 8 rows were planted five weeks after the initial planting date. Sampling kept going on original rows and on August 20 all sampling occurred on the later planted rows. Fruit was harvested and fertilizer was applied as needed to maintain plots. Commercial field sampling was conducted between June 7 and Aug. 14, 2024, following the grower's management schedule. The commercial field had an approximate size of 15 acres of planted pickling cucumbers, with seeds sowed directly on the ground with no plastic and with an overhead irrigation system.

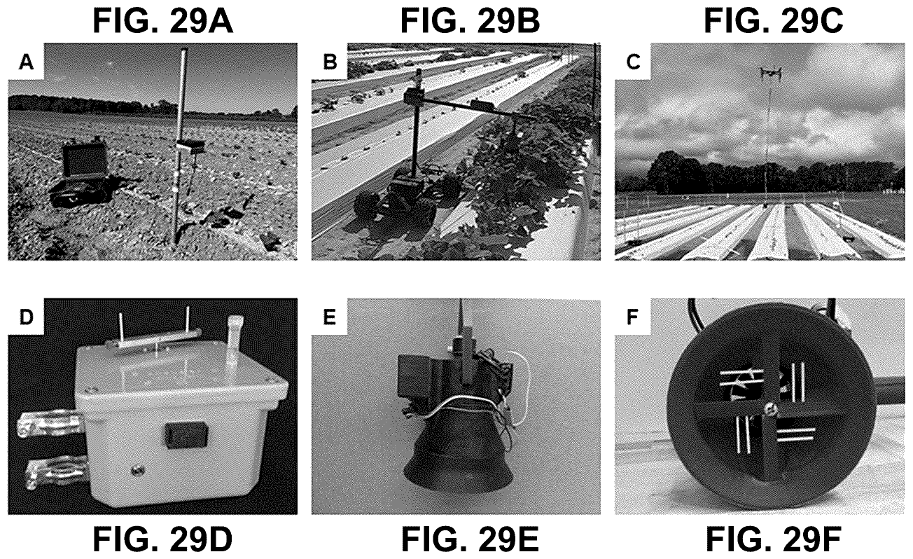

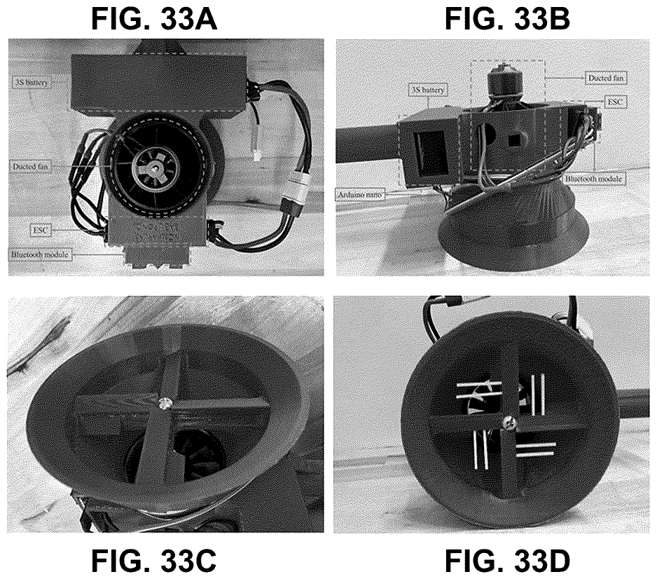

Spore trap sample collection. Spore traps included styrene rods (0.060 in², Plastruct, Des Plaines, IL) coated with high vacuum grease (Dow Corning, Midland, MI). Two trap systems were tested (Table 9, FIGS. 29A-F): (i) rotating arm stationary traps, each holding two rods, and (ii) custom 3D-printed vacuum traps containing up to 104 rods (eight rods used per sample) (FIGS. 33A-D). Two types of sampling vehicles were used. The first was a remote control rover (Eclipse ROVER™, Lewiston Heights, MO) with a custom arm attached to hold the vacuum trap. The second vehicle was a Unmanned Aerial Vehicle (UAV). This UAV is a modified DJI Matrice 100 (DJI™, Cerritos, CA). For UAV sampling, the vacuum trap was suspended by a tether beneath the drone.

TABLE 9
Estimated probability of detection categorized by
the different types of vehicle/trap combinations.

| | | | | Estimated |
|---|---|---|---|---|
| | | Sampling | | Probability of |
| Trap | Type | time | | Detection |
| Drone-Vacuum | Mobile | 10 | minutes | 0.63108 |
| Rover-Vacuum | Mobile | 15 | minutes | 0.50824 |
| Rotating arm | Stationary | 10 | minutes | 0.5137 |
| (Drone control) | | | | |
| Rotating arm | Stationary | 15 | minutes | 0.39586 |
| (Rover control) | | | | |
| Rotating arm | Stationary | 30 | minutes | 0.3654 |
| Rotating arm | Stationary | 60 | minutes | 0.35364 |
| Rotating arm | Stationary | 120 | minutes | 0.39909 |

The sampling conducted at the research station, occurred weekly and the rods were stored in 2 ml tubes once sampling was complete. Sampling was done for 18 weeks between May 24 to September 26 and for 20 weeks between May 22 to September 20, in 2023, and 2024, respectively. All sampling was completed before 10 am. Two trap type categories were used: stationary traps (rotating arm) and mobile traps (rover, drone). For the first category (stationary) three rotating arm traps per crop (one set of three adjacent to a cucumber plot, one set of three adjacent to a squash plot) were set to sample for 30 minutes (8:30 am-9:00 am), 60 minutes (8:00 am-9:00 am) and 120 minutes (7:00 am-9:00 am), every week.

The second category was the mobile vehicles combined with the novel vacuum traps. The rover/vacuum trap combination performed two sampling drives of 15 minutes each. One drive with the vacuum hovering above the canopy of a cucumber row and another drive with the vacuum hovering above a squash row. The drone/vacuum trap combination performed a 10 minute, manually operated flight, with the vacuum trap hovering above the canopy of all rows in the research plot. The rover drive and the UAV flight were performed separately on different days, and control stationary rotating arm traps were run at the same time as the drives and flights, as a control.

Sampling in the commercial cucumber farm occurred on six occasions between June 7th and August 13th in 2024. The types of traps that were used are as follows. One rover drive of 15 mins was performed adjacent to the field, with the vacuum hovering on top of the canopy. The sampling was adjacent since the spacing of the rows in the commercial field did not allow for the rover to be driven in between rows. Several drone flights were performed on a given sampling day. One rotating arm trap was running at the same time as the rover drove/drone flew as a control and was placed approximately 10 mt inside the field.

Disease rating. Disease rating occurred weekly in the research site location. Percent severity of CDM symptoms was assessed on a portion of each of the rows in the research plot.

Spore trap sample processing. Once the rods were collected, they were brought to the lab for analysis. The sample processing included four steps. First, a DNA Extraction was performed using the NucleoSpin Plant II, Mini kit for DNA (Macherey Nagel, Allentown, PA). Second, DNA concentration and quality were checked for each sample using a spectrophotometer (NanoDrop®, Wilmington, DE). The third step was to perform a qPCR assay in the BioRad CFX96 (BioRad, Hercules, CA) coupled with specific primers and probes to determine the clade of each sample. This qPCR assay was done with the same primers. The purpose of this assay was to classify the samples in one of four categories: clade 1, clade 2, both clades, or no detection. The fourth step was to perform a qPCR assay in the BioRad CFX96 (BioRad, Hercules, CA) coupled with specific primers and probes to determine if a sample has the presence of a fungicide resistance mutation for OXTP. The purpose of this assay was to classify the samples in one of four categories: mutation, wildtype (no mutation), both (mixed sample) or no detection. The qPCR for fungicide resistance detection was only performed on samples that had previous detection from the initial qPCR clade assay.

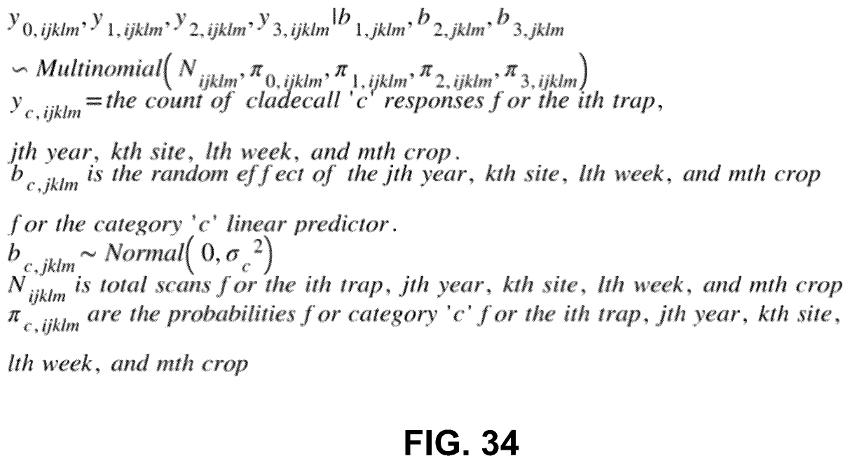

Data analysis. The results from the clade qPCR assay only were modelled as observations using a generalized logistic regression mixed model, with a fixed effect for traps and with random effects (FIG. 34). The approximation of the process was multinomial. The model parameters were estimated in SAS' PROC GLIMMIX.

### 3. Results

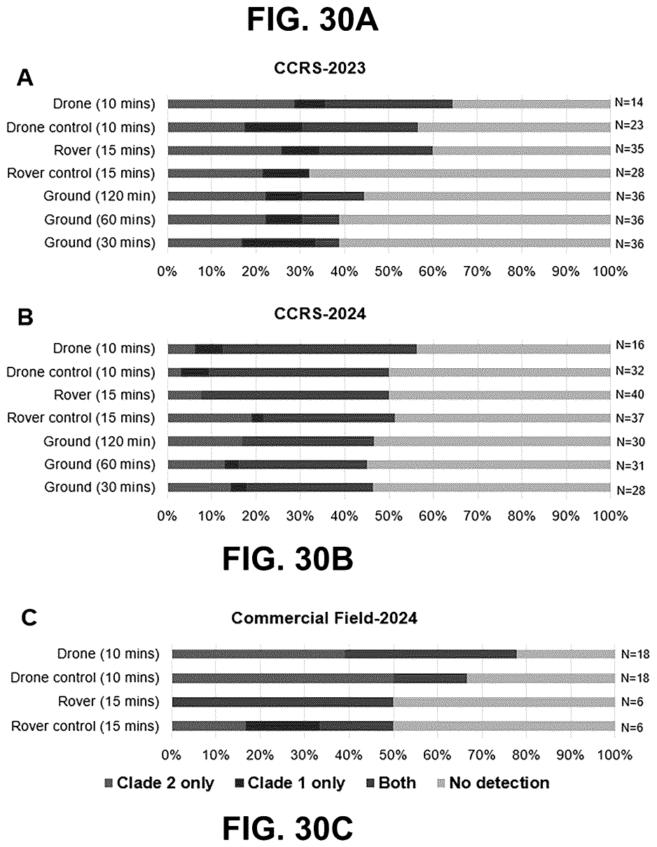

The drone-vacuum trap combination has the highest estimated probability of detection with the lowest sampling time. When taking into account the overall data, including both years in the research station plots as well as the sampling in the commercial cucumber operation, the drone-vacuum vehicle trap combination has the highest estimated probability of detecting P. cubensis sporangia, with a value of 0.63 (Table 9). This is followed by the drone control-rotating arm, the rover-vacuum, the rover control-rotating arm, the 120 min rotating arm, the 30 min rotating arm and finally the 60 minute rotating arm trap combinations (Table 9). The drone-vacuum trap combination had the highest detection percentage across all seasons and sampling locations. In the research plot in 2023, the drone-vacuum trap combination had a detection percentage of 64.3%. In 2024, it was 56.3% and in the same year but in the commercial field it had a 77.8% detection percentage (FIG. 30A-C). It should be noted that the drone-vacuum trap has the lowest sampling time (˜10 minutes) and the lowest sampling events in the research plots. This suggests that the novel drone-vacuum mobile spore trap outperforms the rest of the tested vehicle/trap combinations.

Mobile vacuum spore traps achieve detection before disease visual confirmation on research plots. In the research plot in 2023, the mobile vacuum spore traps (Drone and Rover) had an average percentage of detection of 62.1%, while the stationary rotating arm spore traps (Ground) had an average percentage of detection of 46.6% (FIG. 30A). In 2024 at the research plot, the mobile vacuum traps had an average percentage of detection of 53%, while the stationary rotating arm had an average percentage of detection of 46% (FIG. 30B). The results suggest that there is an advantage in detection when the traps are mobile and actively moving air through the spore trap (vacuum).

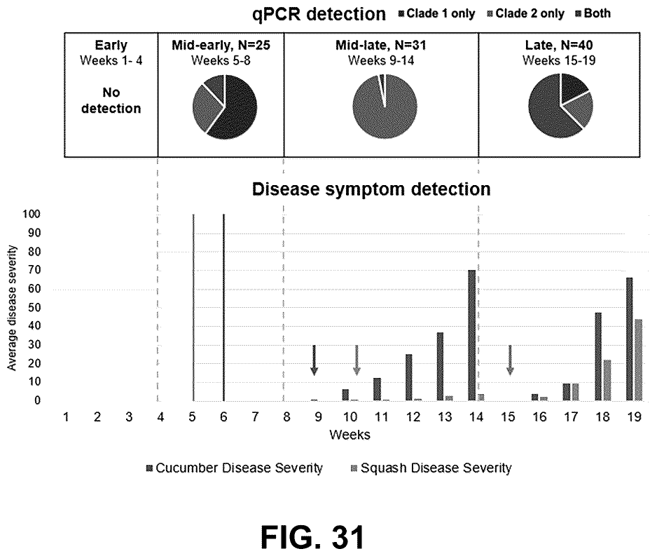

In both years of sampling at the research station, qPCR clade detection was achieved before visual disease identification via scouting happened in the plots. For 2023, the first qPCR detection came from a sample obtained on Jun. 27, 2023 (week 5) from the drone-vacuum spore trap (FIG. 31). This first detection was classified as a clade 2. The first visual identification of CDM symptoms in cucumber happened on Jul. 17, 2023 (week 8) and the first visual identification of CDM symptoms in squash happened on Aug. 8, 2023 (week 11). Add sentences about first detection of clade 1.

In FIG. 31, the season was divided temporally between four stages: early, mid-early, mid-late and late season. In the early season, no detection was achieved with the qPCR and no visible disease symptoms were yet apparent on the plots. In the mid-early season, a total of 25 samples had presence of P. cubensis in all three categories: clade 1, 2 and both clades. During the mid-early season no disease symptoms were observed in the plots. Disease symptoms were observed for both crops in the mid-late and the late part of the season. During the mid-late season, 31 samples had presence of P. cubensis, with the vast majority being classified as a clade 2 only and a few classified as having both clades. This aligned with the disease severity observed on the plots, with cucumber disease severity increasing steadily as weeks went by, while the squash severity remained low. Lastly, in the late part of the season, 40 samples had presence of P. cubensis, with most of them being classified as having both clades, which is congruent with what was being observed in the plots, with both crops increasing disease severity over time. Add some sentences about which traps were able to detect each clade before visual symptoms.

For 2024, the first qPCR detection came from a sample collected on May 22, 2024 from the rover-vacuum trap that was being driven on a cucumber row. This first detection was classified as a clade 2. The first visual identification of CDM symptoms in cucumber happened on Jul. 23, 2024 (week 10) and the first visual identification of CDM symptoms in squash happened on Aug. 1, 2024 (week 11).

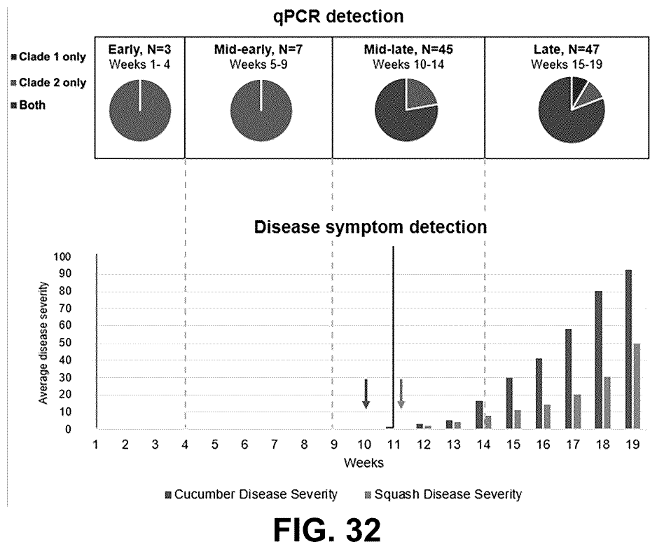

The season was once again divided temporally between four stages: early, mid-early, mid-late and late season (FIG. 32). Although no disease symptoms were observed in the plots during both the early and mid-early parts of the season, P. cubensis was detected. Specifically, in the early season, 3 samples showed its presence and were classified as a clade 2. Moving into the mid-early season, detection increased to 7 samples, also classified as a clade 2. Subsequently, the mid-late part of the season saw a significant increase, with 45 samples detecting the pathogen, the majority of which were classified as having both clades present. Notably, during this period, disease symptoms began to be observed in the plots. Lastly, in the late part of the season, detection reached its highest with 47 samples and again, the majority showed the presence of both clades. This trend is consistent with the observed increase in disease severity over time in the plots. Add some sentences about which traps were able to detect each clade before visual symptoms.

Mobile vacuum spore traps enable successful detection of P. cubensis in production-scale fields. The use of mobile spore trapping proved successful in a production large acreage field in 2024. The drone-vacuum combination had a detection percentage of 77.8%, while its rotating arm counterpart had a detection percentage of 66.7%. The rover-vacuum and its rotating arm counterpart both had a detection percentage of 50% (FIG. 30C). The rover was driven only at the edges of the field while the drone was able to fly above and sample a larger area of the commercial field. The difference in results between the two types of vehicles suggests that spore trapping efforts yield a higher detection percentage when the sampling area increases and the sampling occurs inside the production field as opposed to the edges. This represents the first evidence that mobile spore trapping in the CDM pathosystem is possible in a large acreage setting. Since at the commercial field sampling did not occur weekly, as did in the research station, detection of P. cubensis before visual identification was not achieved.

In some embodiments, a qPCR OXTP fungicide resistance assay can be used in combination with the spore traps and vehicles described herein.

### 4. Discussion

Results indicate that mobile spore trapping is possible in both research plots and large acreage production scale fields. This study provides the first documented evidence supporting the feasibility of mobile spore trapping for CDM surveillance across large-scale production fields. Additionally, the results from the research location provided further support that the use of spore traps combined with qPCR markers provides disease detection before symptoms arise and are visible. Furthermore, the integration of a fungicide resistance marker into this biosurveillance system enables precision disease management that has the potential to minimize unnecessary fungicide use, since it could provide in-season fungicide sensitivity information to growers. This reiterates the importance of spore trapping in combination with different qPCR markers, as a useful tool in informing disease management.

Across both sampling years at the research location as well as in the commercial field, the drone-vacuum combination had consistently the highest detection rate, suggesting reliability across distinct environments. These results suggest that the drone-vacuum trap not only has a higher estimated probability of detection than the traditional rotating arm-based traps, but it does it with less sampling time and less sampling events. The lower number of necessary sampling events that lead to detection has the potential to add to practical scalability in commercial agriculture. The results show that the drone-vacuum still outperforms the rover-vacuum trap combination, which could suggest that not only mobility plays a role but also the scale of mobility, since the drone has the capability of sampling a much larger area and inside the field, especially in the commercial setting.

Early detection of the disease is important for disease forecasting and disease management recommendations. The temporal results (FIG. 31 and FIG. 32) demonstrate that the biosurveillance system has the ability to detect the disease in the early and mid-early parts of the season, before disease symptoms can be visually detected in the plots. This was consistent across the two years of sampling at the research location. Notably, in both years at the research location, the first detection of the season came both times from a mobile trap. In 2023, the first detection came from a drone-vacuum trap sample and in 2024 it was a rover-vacuum trap sample. This early warning capability of the biosurveillance system, combined with shorter sampling times than the traditional ground, rotating arm systems, has the potential to guide timely management interventions.

In 2024, there was a predominance of clade 2 only detection in the early and mid-early part of the season. This is aligned with previous research that suggests that clade 2 arrives earlier than clade 1, in North Carolina. However, this predominance did not occur across years, since in 2023 in the mid-early season, it was clade 1 that was detected more often at this specific time of the season. Nevertheless, this clade 1 detection did not translate into symptoms until much later in the season. The later co-occurrence of both clades in the late stage of the season for both sampling years at the research location, concurrent with rising disease severity, emphasizes the value of genetic differentiation in spore detection.

Collectively, these findings provide compelling support for the use of mobile vacuum spore trapping systems as effective tools for early disease detection of P. cubensis in both research and commercial cucurbit production settings. By integrating qPCR assays for both clade differentiation and fungicide resistance detection, this biosurveillance system not only advances the capacity for pathogen monitoring but also lays the groundwork for in-season precision disease management strategies. The ability to detect airborne spores weeks before visual symptom identification, combined with reduced sampling time and scalability, positions this approach as a valuable addition to integrated pest management programs. However, further refinement is needed, especially in optimizing field sampling frequency. Future research should focus on expanding the geographic and temporal scope of surveillance, and understanding the spatial dynamics of clade distribution. Ultimately, this work highlights the potential of biosurveillance to enhance pathogen monitoring and to support data-driven crop protection.

Therefore, the following is claimed:

1. An apparatus, comprising:
a wind collection lid with a plurality of rod placement compartments;
a ducted fan, wherein the ducted fan is configured to draw air through the wind collection lid;
an electronic speed controller wherein the electronic speed controller controls the speed of the ducted fan; and
a battery wherein the battery is configured to power at least the electronic speed controller and the ducted fan.

2. The apparatus of claim 1, further comprising:
a microcontroller connected to the electronic speed controller; and
a wireless module connected to the microcontroller wherein the wireless module wirelessly receives command signals for the microcontroller.

3. The apparatus of claim 1, wherein at least one of a plurality of collection rods is disposed in at least one of the plurality of rod placement compartments.

4. The apparatus of claim 3, wherein each collection rod of the plurality of collection rods is coated with an adhesive.

5. The apparatus of claim 1, further comprising a portable handle wherein the portable handle is added to aid in transportation of the apparatus.

6. The apparatus of claim 1, further comprising a control switch wherein the ducted fan can be switched on and off via the control switch.

7. An apparatus, comprising:
a plurality of legs, wherein each leg of the plurality of legs has at least three degrees of freedom;
a frame connected to each leg of the plurality of legs;
a sensing system comprising an inertial measurement unit disposed on the frame and a plurality of force sensors disposed on each leg of the plurality of legs;
a control system comprising a motion controller disposed on the frame and a data processor disposed on the frame wherein the motion controller works with the data processor to process information gathered by the sensing system to generate motion commands; and
a battery disposed on the frame wherein the battery is configured to power at least the sensing system and the control system.

8. The apparatus of claim 7, wherein the plurality of legs is six legs.

9. The apparatus of claim 7, wherein each leg of the plurality of legs comprises at least three servos and at least three connectors.

10. The apparatus of claim 9, wherein the three servos of each leg comprise a proximal servo with horizontal rotational degrees of freedom, a medial servo with vertical rotational degrees of freedom, and a distal servo with vertical rotational degrees of freedom.

11. The apparatus of claim 7, wherein the sensing system further comprising a LIDAR, a plurality of cameras, and a plurality of range sensors, wherein the LiDAR, the plurality of cameras, and the plurality of range sensors are configured to acquire real-time data on ground conditions and obstacles.

12. The apparatus of claim 7, wherein the plurality of legs can switch between a high clearance motion mode and a low clearance motion mode.

13. The apparatus of claim 7, wherein the frame and the plurality of legs have a total maximum weight of 10 kilograms.

14. The apparatus of claim 7, wherein the frame and the plurality of legs can maintain a payload of at least 8 kilograms.

15. The apparatus of claim 7, wherein the battery has an operation endurance time of at least 2 hours.

16. A system, comprising:
a bionic robot comprising,
a plurality of legs, wherein each leg of the plurality of legs has at least three degrees of freedom,
a frame connected to each leg of the plurality of legs,
a sensing system comprising an inertial measurement unit disposed on the frame and a plurality of force sensors disposed on each leg of the plurality of legs,
a control system comprising a motion controller disposed on the frame and a data processor disposed on the frame wherein the motion controller works with the data processor to process information gathered by the sensing system to generate motion commands, and
a first battery disposed on the frame wherein the first battery is configured to power at least the sensing system and the control system; and
a vacuum spore trap mounted on the bionic robot, wherein the vacuum spore trap comprises,
a wind collection lid with a plurality of rod placement compartments, wherein at least one of a plurality of collection rods coated in an adhesive is placed in at least one of the plurality of rod placement compartments,
a ducted fan, wherein the ducted fan in configured to draw air through the wind collection lid,
an electronic speed controller wherein the electronic speed controller controls the speed of the ducted fan; and
a second battery wherein the second battery is configured to power at least the electronic speed controller and the ducted fan.

17. The system of claim 16, wherein the bionic robot further comprises: a LiDAR, a plurality of cameras, and a plurality of range sensors, and wherein the LiDAR, the plurality of cameras, and the plurality of range sensors are configured to acquire real-time data on ground conditions and obstacles.

18. The system of claim 16, wherein the vacuum spore trap further comprises:
a microcontroller connected to the electronic speed controller; and
a wireless module connected to the microcontroller wherein the wireless module wirelessly receives command signals for the microcontroller.

19. The system of claim 16, wherein the vacuum spore trap further comprises a portable handle and wherein the vacuum trap is mounted to the bionic robot via the portable handle.

20. The system of claim 16, wherein the plurality of legs is six legs.
